(19) United States
(12) Patent Application Publication
(10) Pub. No.: US 2025/0008560 A1
(43) Pub. Date: Jan. 2, 2025

(54) WIRELESS AUDIO RECEIVING DEVICE, WIRELESS AUDIO TRANSMITTING DEVICE, AND WIRELESS AUDIO SYSTEM INCLUDING THE SAME

(71) Applicant: LG ELECTRONICS INC., Seoul (KR)

(72) Inventors: Seunghyun LEE, Seoul (KR); Jisung YANG, Seoul (KR); Dawoon LEE, Seoul (KR)

(73) Assignee: LG ELECTRONICS INC., Seoul (KR)

(21) Appl. No.: 18/659,860

(22) Filed: May 9, 2024

(30) Foreign Application Priority Data
Jun. 27, 2023 (KR) 10-2023-0082781

(51) Int. Cl. H04W 74/0816; H04R 3/12

(52) U.S. Cl. CPC H04W 74/0816; H04R 3/12; H04R 2420/07

(57) ABSTRACT

The present disclosure relates to a wireless audio transmitting device, a wireless audio receiving device, and a wireless audio output system including the same. The wireless audio transmitting device according to an embodiment of the present disclosure includes a transceiver configured to transmit an audio signal to a wireless audio receiving device through ultra-wideband communication, wherein the transceiver transmits broadcast audio data to at least one wireless audio receiving device not connected to the wireless audio transmitting device by using a guaranteed time slot within a contention free period among a beacon interval including the contention free period, in a first mode for audio sharing. Accordingly, it is possible to conveniently and quickly share wireless audio data through ultra-wideband communication.

### CROSS-REFERENCE TO RELATED APPLICATION(S)

Pursuant to 35 U.S.C. § 119, this application claims the benefit of earlier filing date and right of priority to Korean Application No(s). 10-2023-0082781, filed on Jun. 27, 2023, the contents of which are all incorporated by reference herein in its entirety.

### BACKGROUND

### 1. Field

This disclosure relates to a wireless audio transmitting device, a wireless audio receiving device, and a wireless audio output system including the same, and more particularly, to a wireless audio transmitting device, a wireless audio receiving device, and a wireless audio output system including the same capable of conveniently and quickly sharing wireless audio data through ultra-wideband communication.

### 2. Description of the Related Art

A wireless audio transmitting device wirelessly transmits an audio signal to an external wireless audio receiving device.

In response to this, a wireless audio receiving device wirelessly receives an audio signal from an external wireless audio transmitting device, converts the received audio signal into sound, and outputs the sound.

Meanwhile, in order to avoid interference with surrounding signals or output high-quality sound, research using an ultra-wideband (UWB) communication method between a wireless audio transmitting device and a wireless audio receiving device is being conducted.

Meanwhile, Korean Patent Registration No. 10-0918003 (hereinafter, referred to as prior document) relates to a beacon-enabled broadcast communication system and method, and discloses a method of broadcasting data in a superframe structure based on a 802.15.4 standard.

Meanwhile, according to the prior document, in order to transmit broadcast data, all devices must be connected, and there is a disadvantage in that a time delay must be different for each device.

That is, according to the prior document, there is a disadvantage in that the process of transmitting broadcast data is complicated and takes a considerable amount of time.

### SUMMARY

The disclosure has been made in view of the above problems, and may provide a wireless audio transmitting device, a wireless audio receiving device, and a wireless audio output system including the same capable of easily and quickly sharing wireless audio data through ultra-wideband communication.

The disclosure may further provide a wireless audio transmitting device, a wireless audio receiving device, and a wireless audio output system including the same capable of stably sharing wireless audio data through ultra-wideband communication.

In accordance with an aspect of the present disclosure, a wireless audio transmitting device including a transceiver configured to transmit an audio signal to a wireless audio receiving device through ultra-wideband communication, wherein the transceiver transmits broadcast audio data to at least one wireless audio receiving device not connected to the wireless audio transmitting device by using a guaranteed time slot within a contention free period among a beacon interval including the contention free period, in a first mode for audio sharing.

Meanwhile, the transceiver may transmit a beacon signal including broadcast information of the guaranteed time slot before transmission of the broadcast audio data, in the first mode.

Meanwhile, the beacon signal may further include information on the number of the guaranteed time slot, start information of the guaranteed time slot, and length information of the guaranteed time slot for transmission of the broadcast audio data.

Meanwhile, the beacon signal may further include transmission or reception direction information of the guaranteed time slot and availability information of the guaranteed time slot.

Meanwhile, in the first mode, during a beacon interval including a first period for beacon signal transmission, a second period corresponding to a contention access period, and a third period corresponding to the contention free period, the transceiver may transmit a beacon signal including broadcast information of the guaranteed time slot in the first period, and transmit the broadcast audio data by using the guaranteed time slot in the third period.

Meanwhile, the second period may correspond to a period for broadcast data transmission, and the third period may correspond to a period for unicast data transmission.

Meanwhile, the transceiver may transmit the broadcast audio data to a previously connected wireless audio receiving device, and transmit the broadcast audio data to a wireless audio receiving device not connected to the wireless audio transmitting device.

Meanwhile, the transceiver may transmit unicast audio data to a previously connected wireless audio receiving device by using the guaranteed time slot within the contention free period, in a second mode for audio exclusive transmission.

Meanwhile, the transceiver may transmit a second beacon signal including unicast information of the guaranteed time slot before transmitting the unicast audio data, in the second mode.

Meanwhile, the transceiver may transmit the unicast audio data in the second mode to a previously connected wireless audio receiving device, and in response to receiving broadcast switching information, transmit the beacon signal including the broadcast information of the guaranteed time slot in the first mode, and transmit the broadcast audio data to the at least one wireless audio receiving device by using a guaranteed time slot within the contention free period after transmitting the beacon signal.

Meanwhile, the transceiver may transmit a second beacon signal including unicast information of the guaranteed time slot before transmitting the unicast audio data, in the second mode.

Meanwhile, the second beacon signal may further include information on the number of guaranteed time slot, start information of the guaranteed time slot, length information of the guaranteed time slot, and information related to the wireless audio receiving device connected to the wireless audio transmitting device, for transmission of the unicast audio data.

Meanwhile, the second beacon signal may further include transmission or reception direction information of the guaranteed time slot and availability information of the guaranteed time slot.

Meanwhile, in the second mode, during a beacon interval including a first period configured to transmit a beacon signal, a second period corresponding to a contention access period, and a third period corresponding to the contention free period, the transceiver may transmit a second beacon signal including unicast information of the guaranteed time slot in the first period, and transmit the unicast audio data by using the guaranteed time slot in the third period.

In accordance with another aspect of the present disclosure, a wireless audio receiving device includes: a transceiver configured to receiver an audio signal from a wireless audio transmitting device through ultra-wideband communication; and a sound output device configured to output a sound corresponding to an audio signal from the transceiver, wherein in response to broadcast information of guaranteed time slot being included in a received beacon signal in a state of not being connected to the wireless audio transmitting device, the transceiver receives broadcast audio data based on guaranteed time slot after the beacon signal, and wherein the sound output device outputs a sound corresponding to the broadcast audio data.

Meanwhile, in response to unicast information of guaranteed time slot being included in a received second beacon signal in a state of being connected to the wireless audio transmitting device, the transceiver may receive unicast audio data based on guaranteed time slot after the second beacon signal, and wherein the sound output device outputs a sound corresponding to the unicast audio data.

In accordance with another aspect of the present disclosure, a wireless audio output system includes a wireless audio transmitting device and a wireless audio receiving device, wherein the wireless audio transmitting device includes a transceiver that transmits an audio signal to the wireless audio receiving device through ultra-wideband communication, wherein the transceiver transmits broadcast audio data to at least one non-connected wireless audio receiving device by using a guaranteed time slot within a contention-free period, in a beacon period including the contention free period, in a first mode for audio sharing.

### BRIEF DESCRIPTION OF THE DRAWINGS

The above and other objects, features and advantages of the present disclosure will be more apparent from the following detailed description in conjunction with the accompanying drawings, in which:

FIGS. 1A to 1E are diagrams illustrating a wireless audio system including a wireless audio receiving device and a wireless audio transmitting device according to various embodiments of the present disclosure;

FIG. 2A is an example of an internal block diagram of the wireless audio receiving device of FIGS. 1A to 1E;

FIG. 2B is an example of an internal block diagram of the wireless audio transmitting device of FIGS. 1A to 1E;

FIGS. 3A to 8B are diagrams for explaining an operation of a wireless audio receiving device or a wireless audio transmitting device according to an embodiment of the present disclosure;

FIG. 9A is a diagram illustrating a beacon interval in ultra-wideband communication;

FIG. 9B is a diagram for explaining FIG. 9A;

FIG. 10A is a diagram illustrating an example of an audio exclusive transmission mode in ultra-wideband communication;

FIG. 10B is a diagram illustrating an example of an audio sharing mode in ultra-wideband communication;

FIG. 11A is a flowchart illustrating an operating method of a wireless audio transmitting device according to an embodiment of the present disclosure;

FIG. 11B is a flowchart illustrating an operating method of a wireless audio transmitting device according to another embodiment of the present disclosure; and

FIGS. 12A to 13B are diagrams for explaining FIG. 11A or 11B.

### DETAILED DESCRIPTION

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the “module” and “unit” may be used interchangeably.

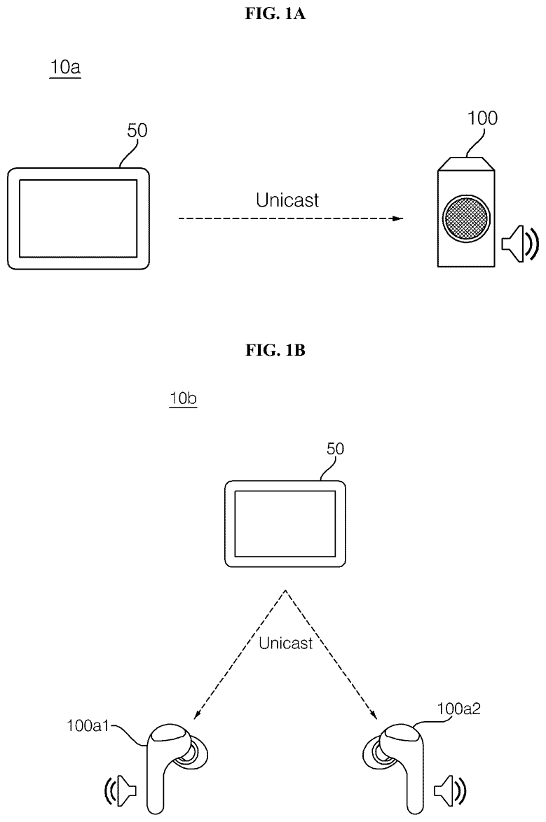

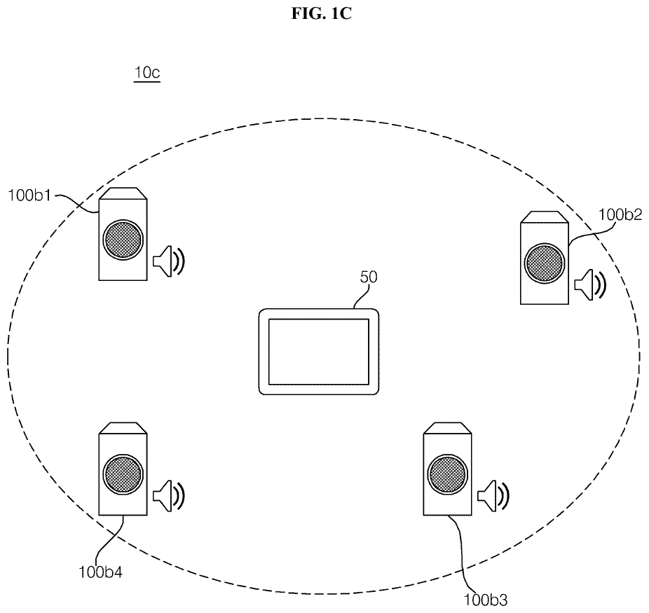

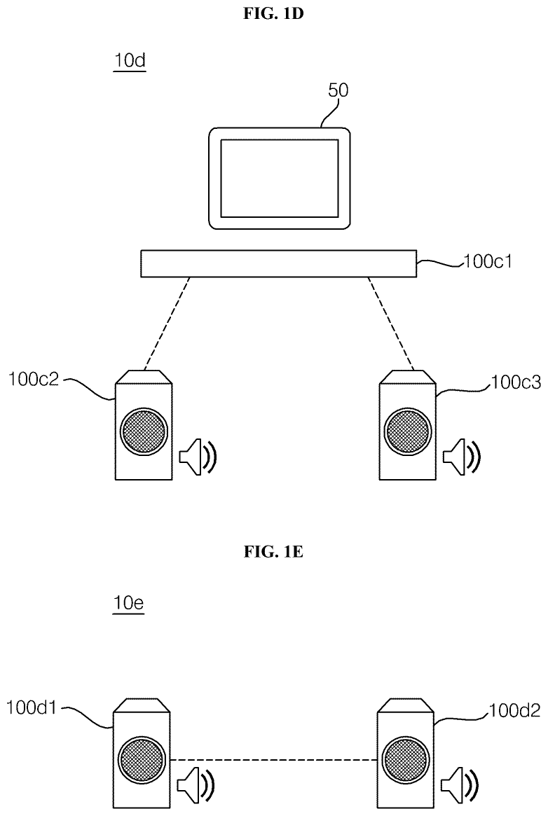

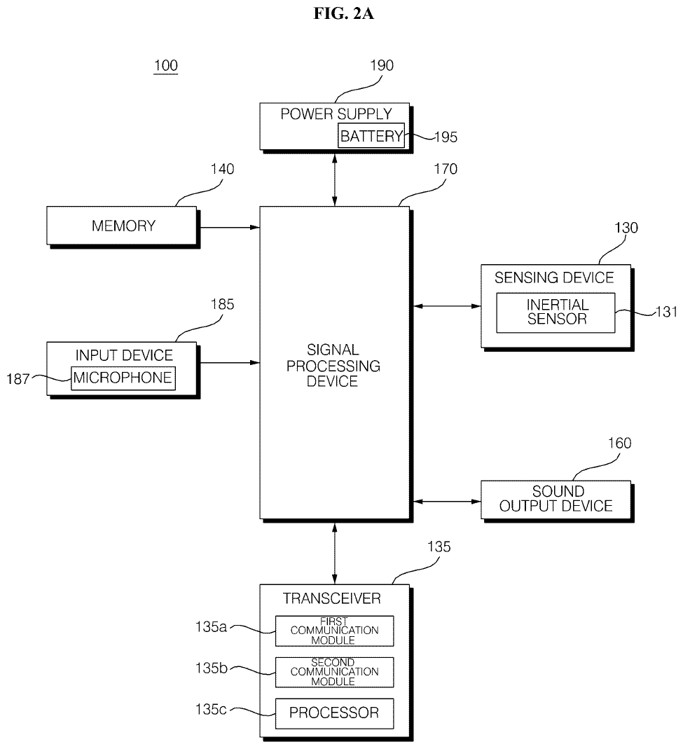

FIGS. 1A to 1E are diagrams illustrating a wireless audio system including a wireless audio receiving device and a wireless audio transmitting device according to various embodiments of the present disclosure.

First, FIG. 1A illustrates a wireless audio system 10a according to an embodiment of the present disclosure.

Referring to FIG. 1A, the wireless audio system 10a according to an embodiment of the present disclosure may include a wireless audio transmitting device 50 and a wireless audio receiving device 100.

In particular, in the wireless audio system 10a, the wireless audio transmitting device 50 and the wireless audio receiving device 100 may correspond one-to-one, based on a unicast method.

The wireless audio transmitting device 50 may include a first communication module 135a wirelessly transmitting a first audio signal according to a first communication standard of a first frequency band, and a second communication module 135b wirelessly transmitting a second audio signal according to a second communication standard of a second frequency band greater than the first frequency band.

Meanwhile, the wireless audio receiving device 100 may include a first communication module 135a wirelessly receiving a first audio signal according to a first communication standard of a first frequency band, and a second communication module 135b wirelessly receiving a second audio signal according to a second communication standard of a second frequency band greater than the first frequency band.

For example, the wireless audio receiving device 100 may wirelessly output a first sound based on a first audio signal according to a first communication standard of a first frequency band received by the first communication module 135a, and when the wireless environment is complicated and the packet error rate of the first audio signal is greater than or equal to a certain value, may output a second sound, based on a second audio signal wirelessly according to the second communication standard of a second frequency band received by the second communication module 135b.

Accordingly, even when the wireless environment is complicated, it is possible to stably receive audio wirelessly and output sound.

Meanwhile, the wireless audio receiving device 100 receives a beacon signal from a first wireless audio transmitting device 50a every period Pc corresponding to a first active period Pa and a first inactive period Pb, and searches for an additional device during the first inactive period Pb. When receiving a second beacon signal from a second wireless audio transmitting device 50b, the wireless audio receiving device 100 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication.

Accordingly, it is possible to perform frequency hopping in ultra-wideband communication, by using a beacon signal. Next, FIG. 1B illustrates a wireless audio system 10b according to another embodiment of the present disclosure.

Referring to FIG. 1B, the wireless audio system 10b according to another embodiment of the present disclosure may include a wireless audio transmitting device 50 and a plurality of wireless audio receiving devices 100al and 100a2.

In particular, the wireless audio system 10b may include a wireless audio transmitting device 50 and a plurality of wireless audio receiving devices 100al and 100a2, based on a unicast method.

For example, when wireless audio signals of a first channel to a second channel are output from the wireless audio transmitting device 50, a wireless audio signal of the first channel may be transmitted to a first wireless audio receiving device 100al among a plurality of wireless audio receiving devices 100al and 100a2, and a wireless audio signal of the second channel may be transmitted to a second wireless audio receiving device 100a2. Accordingly, even when the wireless environment is complicated, it is possible to stably receive audio wirelessly and output sound.

Meanwhile, each of the wireless audio receiving devices 100al to 100a2 wirelessly outputs a first sound, based on a first audio signal according to a first communication standard of a first frequency band received by a first communication module 135a. In response to a packet error rate of the first audio signal is greater than or equal to a certain value as the wireless environment is complicated, each of the wireless audio receiving devices 100al to 100a2 may output a second sound, based on a second audio signal according to a second communication standard of a second frequency band received by a second communication module 135b. Accordingly, even when the wireless environment is complicated, it is possible to stably receive audio wirelessly and output sound.

Meanwhile, each of the wireless audio receiving devices 100al to 100a2 receives a beacon signal from a first wireless audio transmitting device 50a every period Pc corresponding to a first active period Pa and a first inactive period Pb, and searches for an additional device during the first inactive period Pb. When receiving a second beacon signal from a second wireless audio transmitting device 50b, each of the wireless audio receiving devices 100al to 100a2 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

At this time, the plurality of wireless audio receiving devices 100al and 100a2 may be left and right wireless audio receiving devices, respectively.

Next, FIG. 1C illustrates a wireless audio system 10c according to another embodiment of the present disclosure.

Referring to FIG. 1C, a wireless audio system 10c according to another embodiment of the present disclosure may include a wireless audio transmitting device 50 and a plurality of wireless audio receiving devices 100b1 to 100b4.

In particular, the wireless audio system 10c may include a wireless audio transmitting device 50 and a plurality of wireless audio receiving devices 100b1 to 100b4, based on a broadcast method.

For example, when wireless audio signals of first to fourth channels are output from the wireless audio transmitting device 50, a wireless audio signal of a first channel may be transmitted to a first wireless audio receiving device 100b1 among a plurality of wireless audio receiving devices 100b1 to 100b4, a wireless audio signal of a second channel may be transmitted to a second wireless audio receiving device 100b2, a wireless audio signal of a third channel may be transmitted to a third wireless audio receiving device 100b3, and a wireless audio signal of a fourth channel may be transmitted to a fourth wireless audio receiving device 100b4. Accordingly, even when the wireless environment is complicated, it is possible to stably receive audio wirelessly and output sound.

Meanwhile, each of the wireless audio receiving devices 100b1 to 100b4 wirelessly outputs a first sound, based on a first audio signal according to a first communication standard of a first frequency band received by the first communication module 135a. In response to a packet error rate of the first audio signal is greater than or equal to a certain value as the wireless environment is complicated, each of the wireless audio receiving devices 100b1 to 100b4 may output a second sound, based on a second audio signal according to a second communication standard of a second frequency band received by the second communication module 135b. Accordingly, even when the wireless environment is complicated, it is possible to stably receive audio wirelessly and output sound.

Meanwhile, each of the wireless audio receiving devices 100b1 to 100b4 receives a beacon signal from a first wireless audio transmitting device 50a every period Pc corresponding to a first active period Pa and a first inactive period Pb, and searches for an additional device during the first inactive period Pb. When receiving a second beacon signal from a second wireless audio transmitting device 50b, each of the wireless audio receiving devices 100b1 to 100b4 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

Next, FIG. 1D illustrates a wireless audio system 10d according to another embodiment of the present disclosure.

Referring to FIG. 1D, the wireless audio system 10d according to another embodiment of the present disclosure may include a wireless audio transmitting device 50 and a plurality of wireless audio receiving devices 100c1 to 100c3.

In particular, the wireless audio system 10d may include a wireless audio transmitting device 50 and a plurality of wireless audio receiving devices 100cl to 100c3, based on a unicast method.

For example, when wireless audio signals of first to third channels are output from the wireless audio transmitting device 50, a wireless audio signal of a first channel may be transmitted to a first wireless audio receiving device 100cl among a plurality of wireless audio receiving devices 100cl to 100c3, a wireless audio signal of a second channel may be transmitted to a second wireless audio receiving device 100c2, and a wireless audio signal of a third channel may be transmitted to a third wireless audio receiving device 100c3.

As another example, when wireless audio signals of first to third channels are output from the wireless audio transmitting device 50, wireless audio signals of a first channel to a third channel may be transmitted to a first wireless audio receiving device 100cl among a plurality of wireless audio receiving devices 100cl to 100c3, the first wireless audio receiving device 100cl may output wireless audio signals of second to third channels, a wireless audio signal of the second channel may be transmitted to a second wireless audio receiving device 100c2, and a wireless audio signal of the third channel may be transmitted to a third wireless audio receiving device 100c3.

Accordingly, even when the wireless environment is complicated, it is possible to stably receive audio wirelessly and output sound.

Meanwhile, each of the wireless audio receiving devices 100c1 to 100c3 wirelessly outputs a first sound, based on a first audio signal according to a first communication standard of a first frequency band received by the first communication module 135a. In response to a packet error rate of the first audio signal is greater than or equal to a certain value as the wireless environment is complicated, each of the wireless audio receiving devices 100c1 to 100c3 may output a second sound, based on a second audio signal according to a second communication standard of a second frequency band received by the second communication module 135b. Accordingly, even when the wireless environment is complicated, it is possible to stably receive audio wirelessly and output sound.

Meanwhile, each of the wireless audio receiving devices 100cl to 100c3 receives a beacon signal from a first wireless audio transmitting device 50a every period Pc corresponding to a first active period Pa and a first inactive period Pb, and searches for an additional device during the first inactive period Pb. When receiving a second beacon signal from a second wireless audio transmitting device 50b, each of the wireless audio receiving devices 100cl to 100c3 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

Next, FIG. 1E illustrates a wireless audio system 10e according to another embodiment of the present disclosure.

Referring to FIG. 1E, a wireless audio system 10e according to another embodiment of the present disclosure may include a plurality of wireless audio receiving devices 100d1 and 100d2.

In particular, the wireless audio system 10e may include a plurality of wireless audio receiving devices 100d1 and 100d2, based on a unicast method.

For example, when a wireless audio signal is output from the first wireless audio receiving device 100d1, the wireless audio signal may be transmitted to the second wireless audio receiving device 100d2.

Accordingly, even when the wireless environment is complicated, it is possible to stably receive audio wirelessly and output sound.

Meanwhile, each of the wireless audio receiving devices 100d1 and 100d2 wirelessly outputs a first sound, based on a first audio signal according to a first communication standard of a first frequency band received by the first communication module 135a. In response to a packet error rate of the first audio signal is greater than or equal to a certain value as the wireless environment is complicated, each of the wireless audio receiving devices 100d1 and 100d2 may output a second sound, based on a second audio signal according to a second communication standard of a second frequency band received by the second communication module 135b. Accordingly, even when the wireless environment is complicated, it is possible to stably receive audio wirelessly and output sound.

Meanwhile, each of the wireless audio receiving devices 100d1 and 100d2 receives a beacon signal from a first wireless audio transmitting device 50a every period Pc corresponding to a first active period Pa and a first inactive period Pb, and searches for an additional device during the first inactive period Pb. When receiving a second beacon signal from a second wireless audio transmitting device 50b, each of the wireless audio receiving devices 100d1 and 100d2 transmits a connection request command to the second wireless audio transmitting device 50b, and based on the connection request command, additionally wirelessly connects to the second wireless audio transmitting device 50b based on ultra-wideband communication, during wireless connection with the first wireless audio transmitting device 50a based on ultra-wideband communication. Accordingly, it is possible to perform frequency hopping in ultra-wideband communication, by using a beacon signal.

Meanwhile, the wireless audio transmitting device 50 illustrated in FIGS. 1A to 1E may be a mobile terminal, a TV, a monitor, a tablet, a home appliance, a vehicle display device, and the like.

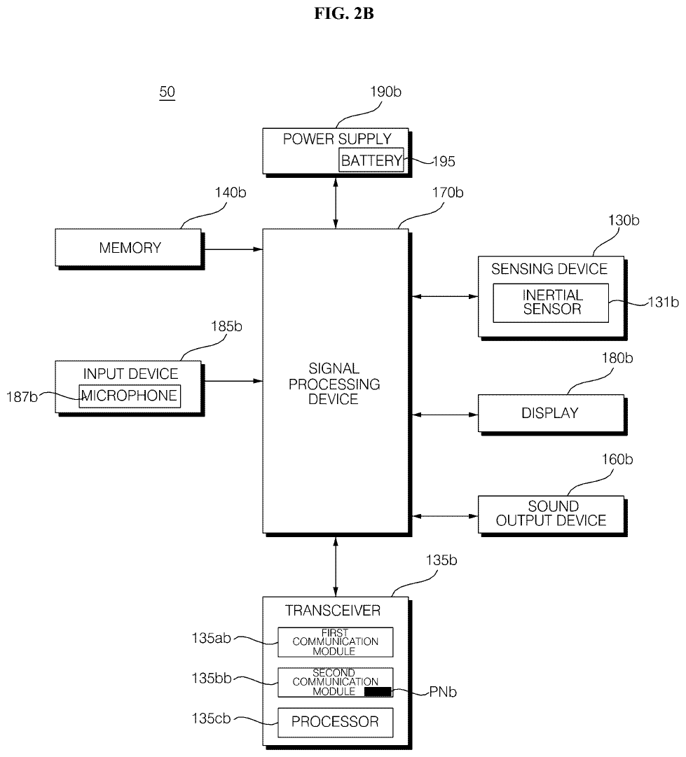

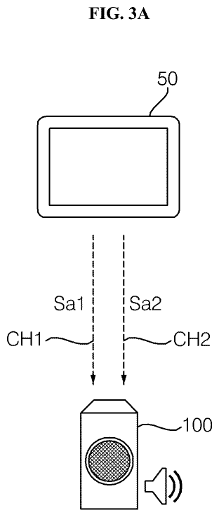

FIG. 2A is an example of an internal block diagram of the wireless audio receiving device of FIGS. 1A to 1E.

Referring to FIG. 2A, the wireless audio receiving device 100 may include a sensing device 130, a transceiver 135, a memory 140, a sound output device 160, a signal processing device 170, an input device 185, and a power supply 190. When these components are implemented in actual applications, if necessary, two or more components may be combined into one component, or one component may be subdivided into two or more components.

The sensing device 130 may include an inertial sensor 131. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130 may output motion information of the wireless audio receiving device 100, for example, movement information (acceleration information, angular velocity information) or location information based on x, y, z axis.

Meanwhile, the sensing device 130 may include a sensor for obtaining user body information. For example, a blood pressure sensor, a brain wave sensor, or the like may be provided.

Meanwhile, the transceiver 135 may provide an interface for communication with an external device. To this end, the transceiver 135 may include at least one of a mobile communication module (not shown), a wireless Internet module (not shown), a short-distance communication module (not shown), or a GPS module (not shown).

For example, the transceiver 135 may perform IR communication, Bluetooth communication, or WiFi communication, thereby exchanging data with a paired wireless audio transmitting device 50 or transmitting data. In particular, it may receive an audio signal from the paired wireless audio transmitting device 50.

Meanwhile, the transceiver 135 may include a first communication module 135a that wirelessly receives a first audio signal according to a first communication standard of a first frequency band, and a second communication module 135b that wirelessly receives a second audio signal according to a second communication standard of a second frequency band greater than the first frequency band.

Meanwhile, the transceiver 135 may further include a processor 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, even when the wireless environment is complicated, it is possible to stably receive audio wirelessly and output sound. In addition, signal data and audio data can be distinguished in the first communication module 135a and the second communication module 135b, so that audio can be stably received wirelessly and sound can be output.

Meanwhile, the beacon signal received by the second communication module 135b may include unicast information or broadcast information. Accordingly, it is possible to operate by dividing into unicast and broadcast.

Meanwhile, when unicast information is included in the received beacon signal, the second communication module 135b may transmit association request information to the wireless audio transmitting device 50 or 100, and may receive association response information from the wireless audio transmitting device 50 or 100. Accordingly, it is possible to operate by dividing into unicast and broadcast.

Meanwhile, the second communication module 135b may distinguish whether it is the second signal data or the second audio data, based on identification information in the header among the received second audio signal. Accordingly, signal data and audio data can be distinguished, thereby stably receiving audio wirelessly and outputting sound.

Meanwhile, the second communication module 135b may distinguish whether it is the second signal data or the second audio data, based on identification information in a media access control (MAC) header or a physical (PHY) header among the received second audio signal. Accordingly, signal data and audio data can be distinguished, thereby stably receiving audio wirelessly and outputting sound.

Meanwhile, when receiving the second signal data, the second communication module 135b may extract encoding or decoding information of the second standard, and based on the extracted encoding or decoding information, may receive the second audio data after the second signal data, and may set a replay time of the second audio data. Accordingly, signal data and audio data can be distinguished, thereby stably receiving audio wirelessly and outputting sound.

The memory 140 may store programs for processing or controlling the signal processing device 170 in the wireless audio receiving device 100, or may perform a function for temporarily storing input or output data.

The sound output device 160 may output an audio signal processed by the signal processing device 170 in the wireless audio receiving device 100.

Alternatively, the sound output device 160 may output guide information related to the operation of the wireless audio receiving device 100 as an audio signal.

Meanwhile, the sound output device 160 may output a first sound corresponding to the first audio signal from the first communication module 135a or a second sound corresponding to the second audio signal from the second communication module 135b.

The signal processing device 170 may control the overall operation of the wireless audio receiving device 100 by controlling the operation of each unit in the wireless audio receiving device 100.

Meanwhile, the signal processing device 170 may perform signal processing for an audio signal received from the outside.

Meanwhile, the signal processing device 170 may replay an audio signal from the first communication module 135a or the second communication module 135b.

Meanwhile, the signal processing device 170 may replay the second audio data, based on the decoding information from the second communication module 135b and a set replay time. Accordingly, signal data and audio data can be distinguished, thereby stably receiving audio wirelessly and outputting sound.

Meanwhile, the input device 185 may include a button for initializing the wireless audio receiving device 100, or inputting an operation.

Meanwhile, the input device 185 may include a microphone 187 for sound collection.

Meanwhile, the input device 185 may include a camera (not shown) for capturing images.

For example, as shown in FIG. 2A, the input device 185 may include a power key (not shown) for turning power on or off, a FF/REW key (not shown) for going forward or backward in the reproducing audio, a volume key (not shown) for volume up or down, a pause/play key (not shown) for playing or pausing audio, and the like.

The power supply 190 may supply power required for operation of each component under the control of the signal processing device 170.

In particular, the power supply 190 may include a battery 195 that stores and outputs DC power.

FIG. 2B is an example of an internal block diagram of the wireless audio receiving device of FIGS. 1A to 1E.

Referring to FIG. 2A, the wireless audio transmitting device 50 may include a sensing device 130b, a transceiver 135b, a memory 140b, a sound output device 160b, a signal processing device 170b, a display 180b, an input device 185b, and a power supply 190b. When these components are implemented in actual applications, if necessary, two or more components may be combined into one component, or one component may be subdivided into two or more components.

The sensing device 130b may include an inertial sensor 131b. The inertial sensor may include an acceleration sensor, a gyro sensor, a gravity sensor, or the like. For example, the acceleration sensor, the gyro sensor, the gravity sensor, and the like may include a 6-axis sensor.

The sensing device 130b may output motion information of the wireless audio transmitting device 50, for example, movement information (acceleration information, angular velocity information) or location information based on x, y, z axis.

Meanwhile, the sensing device 130b may include a sensor for obtaining user body information. For example, a blood pressure sensor, a brain wave sensor, or the like may be provided.

Meanwhile, the transceiver 135b may provide an interface for communication with an external device. To this end, the transceiver 135b may include at least one of a mobile communication module (not shown), a wireless Internet module (not shown), a short-distance communication module (not shown), or a GPS module (not shown).

For example, the transceiver 135b may perform IR communication, Bluetooth communication, or WiFi communication, thereby exchanging data with a paired wireless audio receiving device 100 or transmitting data. In particular, it may transmit an audio signal to the paired wireless audio receiving device 100.

Meanwhile, the transceiver 135b may include a first communication module 135ab for wirelessly transmitting a first audio signal according to a first communication standard of a first frequency band, and a second communication module 135bb for wirelessly transmitting a second audio signal according to a second communication standard of a second frequency band (e.g. ultra-wideband) greater than the first frequency band.

Meanwhile, the second communication module 135bb may include a personal area network (PAN) coordinator PNb for ultra-wideband communication.

Meanwhile, the transceiver 135b may further include a processor 135cb for signal processing or control of the first communication module 135ab and the second communication module 135bb.

Meanwhile, the first communication module 135ab transmits a first signal data through a first channel CH1b, and separately transmits a first audio data through a second channel CH2, and the second communication module 135bb separately transmits a second signal data and a second audio data through the same channel CHm.

Accordingly, even when the wireless environment is complicated, it is possible to stably transmit an audio signal wirelessly. In addition, signal data and audio data can be distinguished in the first communication module 135ab and the second communication module 135bb, so that audio signals can be stably transmitted wirelessly.

Meanwhile, the beacon signal transmitted from the second communication module 135bb may include unicast information or broadcast information. Accordingly, it is possible to operate by dividing into unicast and broadcast.

Meanwhile, when unicast information is included in the transmitted beacon signal, the second communication module 135bb may receive association request information from the wireless audio receiving device 100, and transmit association response information to the wireless audio receiving device 100. Accordingly, it is possible to operate by dividing into unicast and broadcast.

Meanwhile, the second communication module 135bb may distinguish whether it is a second signal data or a second audio data, based on identification information in a header among the transmitted second audio signal. Accordingly, signal data and audio data can be distinguished, thereby stably transmitting an audio signal wirelessly.

Meanwhile, the second communication module 135bb may distinguish whether it is a second signal data or a second audio data, based on identification information in a media access control (MACb) header or a physical (PHYb) header among the transmitted second audio signal. Accordingly, signal data and audio data can be distinguished, thereby stably transmitting an audio signal wirelessly.

The memory 140b may store a program for processing or controlling the signal processing device 170b in the wireless audio transmitting device 50, or may perform a function for temporarily storing input or output data.

The sound output device 160b may output an audio signal processed by the signal processing device 170b in the wireless audio transmitting device 50.

Alternatively, the sound output device 160b may output guide information related to the operation of the wireless audio transmitting device 50 as an audio signal.

The signal processing device 170b may control the overall operation of the wireless audio transmitting device 50 by controlling the operation of each unit in the wireless audio transmitting device 50.

Meanwhile, the signal processing device 170b may perform signal processing for an audio signal received from the outside.

Meanwhile, the signal processing device 170b may control the operation of each unit, based on data from the first communication module 135ab or the second communication module 135bb.

The display 180b may include LCD, OLED, LED, micro LED, or the like.

Meanwhile, the input device 185b may include a button or the like for initializing or inputting an operation of the wireless audio transmitting device 50.

Meanwhile, the input device 185b may include a microphone 187b for sound collection.

Meanwhile, the input device 185b may include a camera (not shown) for capturing images.

For example, as shown in FIG. 2B, the input device 185b may include a power key (185ab) for turning power on or off, a FF/REW key (185bb) for going forward or backward in the reproducing audio, a volume key (185cb) for volume up or down, a pause/play key (185db) for playing or pausing audio, and the like.

The power supply 190b may supply power required for operation of each component under the control of the signal processing device 170b.

In particular, the power supply 190b may include a battery 195b that stores and outputs DC power.

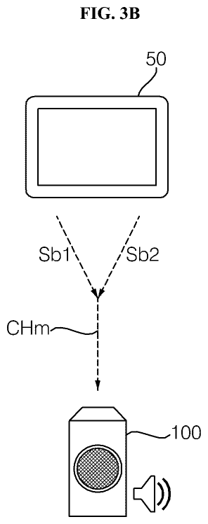

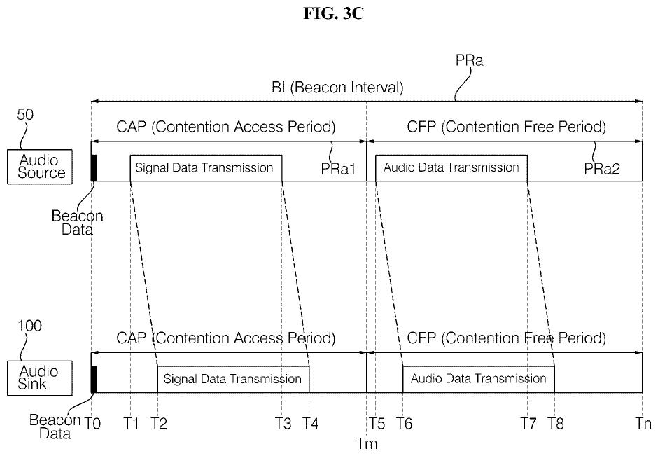

FIGS. 3A to 8B are diagrams for explaining an operation of a wireless audio receiving device or a wireless audio transmitting device according to an embodiment of the present disclosure.

FIG. 3A illustrates that the wireless audio transmitting device 50 outputs a first signal data Sa1 and a first audio data Sa2 to the wireless audio receiving device 100.

Referring to FIG. 3A, the wireless audio transmitting device 50 wirelessly outputs the first signal data Sa1 and the first audio data Sa2 according to a first communication standard of a first frequency band.

In particular, the wireless audio transmitting device 50 may transmit the first signal data Sa1 through the first channel CH1, and separately transmit the first audio data Sa2 through the second channel CH2.

Accordingly, the first communication module 135a in the wireless audio receiving device 100 according to an embodiment of the present disclosure receives the first signal data Sa1 through the first channel CH1, and distinguishes and receives the first audio data Sa2 through the second channel CH2.

FIG. 3B illustrates that the wireless audio transmitting device 50 outputs the second signal data Sb1 and the second audio data Sb2 to the wireless audio receiving device 100.

Referring to FIG. 3B, the wireless audio transmitting device 50 wirelessly outputs the second signal data Sb1 and the second audio data Sb2 according to a second communication standard of a second frequency band greater than the first frequency band.

In particular, the wireless audio transmitting device 50 may separately transmit the second signal data Sb1 and the second audio data Sb2 through the same channel CHm.

Accordingly, the second communication module 135b in the wireless audio receiving device 100 according to an embodiment of the present disclosure separately receives the second signal data Sb1 and the second audio data Sb2 through the same channel CHm.

Meanwhile, the first communication standard may be a Bluetooth communication standard, and the second communication standard may be an ultra-wideband (UWB) communication standard.

For example, the wireless audio transmitting device 50 may wirelessly transmit an audio signal according to the first communication standard, and then wirelessly transmit the audio signal according to the second communication standard when the wireless environment is complicated.

Accordingly, the wireless audio receiving device 100 may stably receive audio wirelessly and output sound even when the wireless environment is complicated. In addition, signal data and audio data can be distinguished in the first communication module 135a and the second communication module 135b, so that audio can be stably received wirelessly and sound can be output.

Meanwhile, the first communication module 135a according to an embodiment of the present disclosure may transmit the first signal data Sa1 through the first channel CH1, and separately transmit the first audio data Sa2 through the second channel CH2, and the second communication module 135b may separately transmit the second signal data Sb1 and the second audio data Sb2 through the same channel CHm. Accordingly, it is possible to stably transmit audio wirelessly even in a complicated wireless environment. In addition, signal data and audio data may be transmitted separately.

Meanwhile, the beacon signal transmitted from the second communication module 135b in the wireless audio transmitting device 50 may include unicast information or broadcast information. Accordingly, it is possible to operate by dividing into unicast and broadcast.

Meanwhile, when unicast information is included in the transmitted beacon signal, the second communication module 135b in the wireless audio transmitting device 50 may receive association request information from the wireless audio receiving device 100, and transmit association response information from an electronic device to the wireless audio receiving device 100. Accordingly, it is possible to operate by dividing into unicast and broadcast. In addition, it is possible to check whether ultra-wideband (UWB) wireless audio support is possible and transmit audio data wirelessly.

Meanwhile, the second communication module 135b in the wireless audio transmitting device 50 may add identification information in a media access control (MAC) header or a physical (PHY) header in order to distinguish whether the transmitted second audio signal is the second signal data Sb1 or the second audio data Sb2. Accordingly, it is possible to operate by dividing into unicast and broadcast.

Meanwhile, when the first communication module 135a in the wireless audio transmitting device 50 transmits the first audio signal and then the second communication module 135b transmits the second audio signal, Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard. Accordingly, signal data and audio data can be distinguished, thereby stably transmitting audio wirelessly.

Meanwhile, when the first communication module 135a in the wireless audio transmitting device 50 transmits the first audio signal and then the second communication module 135b transmits the second audio signal, an adaptation layer (AL) may be used to map data of the first communication standard to data of the second communication standard. Accordingly, signal data and audio data can be distinguished, thereby stably transmitting audio wirelessly.

Meanwhile, when the second communication module 135b in the wireless audio transmitting device 50 transmits the second audio signal, it may transmit the second signal data Sb1 in a contention access period (CAP) of the beacon interval PRa, and may transmit the second audio data Sb2 in a contention free period (CFP) of the beacon interval PRa. Accordingly, signal data and audio data can be distinguished, thereby stably transmitting audio wirelessly.

Meanwhile, the first communication module 135a in the wireless audio transmitting device 50 may transmit the first signal data Sa1 and transmit identification information in the first signal data Sa1 to the second communication module 135b, and the second communication module 135b may separately transmit the second signal data Sb1 in the second audio signal, based on the identification information from the first communication module 135a. Accordingly, signal data and audio data can be distinguished, thereby stably transmitting audio wirelessly.

Meanwhile, the first communication module 135a in the wireless audio transmitting device 50 may transmit the first audio data Sa2 and transmit identification information in the first audio data Sa2 to the second communication module 135b, and the second communication module 135b may separately transmit the second audio data Sb2 in the second audio signal, based on the identification information from the first communication module 135a. Accordingly, signal data and audio data can be distinguished, thereby stably transmitting audio wirelessly.

Meanwhile, the second communication module 135b in the wireless audio transmitting device 50 may receive a security activation value from the wireless audio receiving device 100, and if it matches, generate a key, and encrypt and transmit the second audio data Sb2 by using the generated key. Accordingly, it is possible to stably transmit audio wirelessly based on security.

FIG. 3C is a diagram for explaining the operation of the wireless audio transmitting device 50 and the first communication module 135a of the wireless audio receiving device 100.

Referring to FIG. 3, the wireless audio transmitting device 50 may wirelessly transmit beacon data at time To during the beacon interval PRa, and the wireless audio receiving device 100 may wirelessly receive the beacon data.

Meanwhile, the wireless audio transmitting device 50 may transmit signal data in a contention access period (CAP) of the beacon interval PRa, and transmit audio data in a contention free period (CFP) of the beacon interval PRa.

In particular, FIG. 3 illustrates that signal data is transmitted between time T1 and time T3 within a contention access period (CAP), and audio data is transmitted between time T5 and time T7 within a contention free period (CFP).

In response, the wireless audio receiving device 100 may receive signal data between time T2 and time T4 within a contention access period (CAP), and may receive audio data between time T6 and time T8 within a contention free period (CFP).

That is, when the second communication module 135b in the wireless audio receiving device 100 receives the second audio signal, it may receive the second signal data Sb1 in the contention access period (CAP) of the beacon interval PRa, and may receive the second audio data Sb2 in the contention free period (CFP) of the beacon interval PRa. Accordingly, signal data and audio data can be distinguished, thereby stably receiving audio wirelessly and outputting sound.

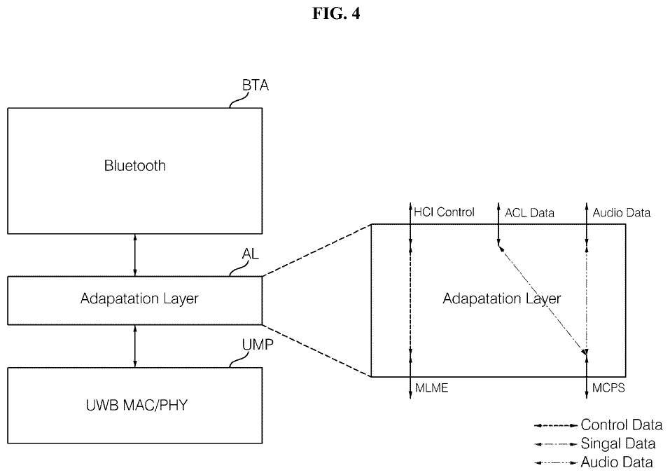

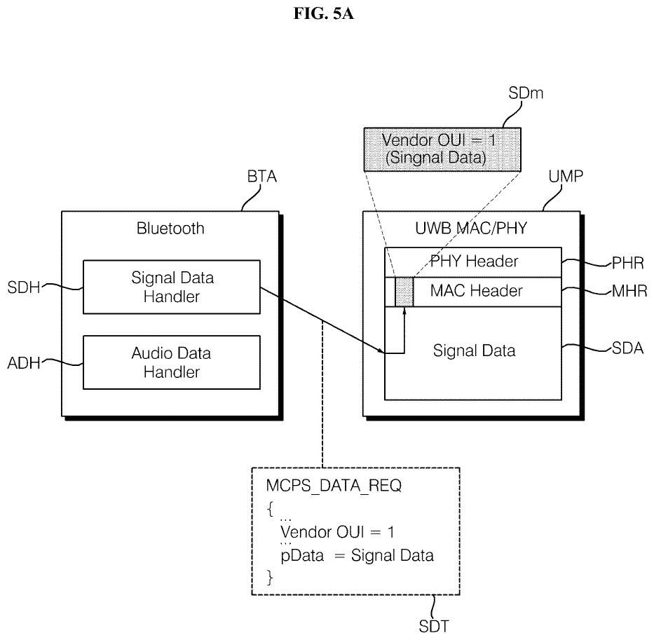

FIG. 4 is a diagram for explaining mapping between a first communication standard and a second communication standard.

Referring to FIG. 4, in order to provide a UWB audio service which is an example of the second communication standard, Bluetooth audio, which is an example of the first communication standard optimized for the audio service, is adopted as an upper protocol.

Bluetooth audio (BTA) interface is composed of HCI Control, ACL Data, and Audio Data.

Meanwhile, the Media access control or physical layer (MAC/PHY) (UMP) of UWB may have a MAC Layer Management Entity (MLME) interface and a MAC Common Part Sublayer (MCPS) interface.

Meanwhile, for mapping between Bluetooth audio (BTA) and UWB media access control or a physical layer (MAC/PHY) (UMP), an adaptation layer (AL) is utilized in an embodiment of the present disclosure.

In the adaptation layer (AL), Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard.

Meanwhile, UWB wireless transmission or UWB wireless reception has a frequency band 3.1 GHz to 10.6 GHz different from the unlicensed band 2.4 GHZ, thereby avoiding frequency interference with other wireless devices using the unlicensed band, and solving problems such as audio interruption.

In addition, since UWB wireless transmission or UWB wireless reception provides a higher PHY data rate than Bluetooth wireless transmission or wireless reception, high-quality audio service is possible.

Meanwhile, when the first communication module 135a receives the first audio signal and then the second communication module 135b receives the second audio signal, Host Control Interface (HCI) data of the first communication standard may be mapped to the MAC Layer Management Entity (MLME) interface of the second communication standard, and Asynchronous Connection-Less (ACL) data and audio data of the first communication standard may be mapped to the MAC Common Part Sublayer (MCPS) interface of the second communication standard. Accordingly, signal data and audio data can be distinguished, thereby stably receiving audio wirelessly and outputting sound.

Meanwhile, when the first communication module 135a receives the first audio signal and then the second communication module 135b receives the second audio signal, data of the first communication standard may be mapped to data of the second communication standard by using an adaptation layer AL. Accordingly, signal data and audio data can be distinguished, thereby stably receiving audio wirelessly and outputting sound.

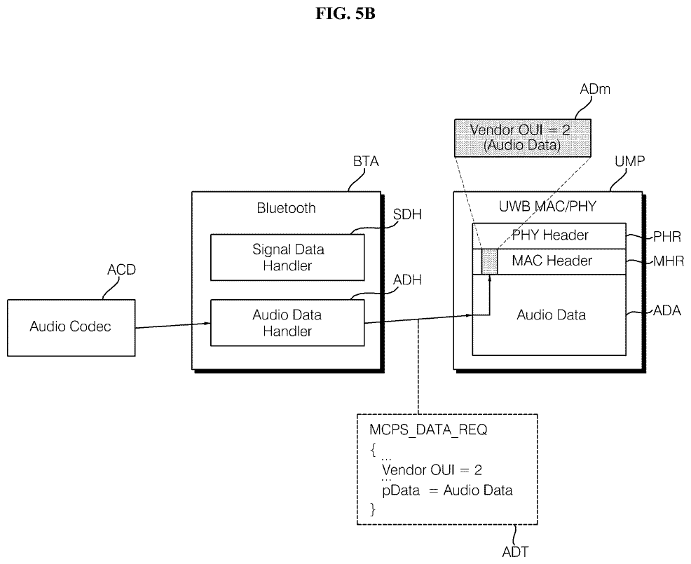

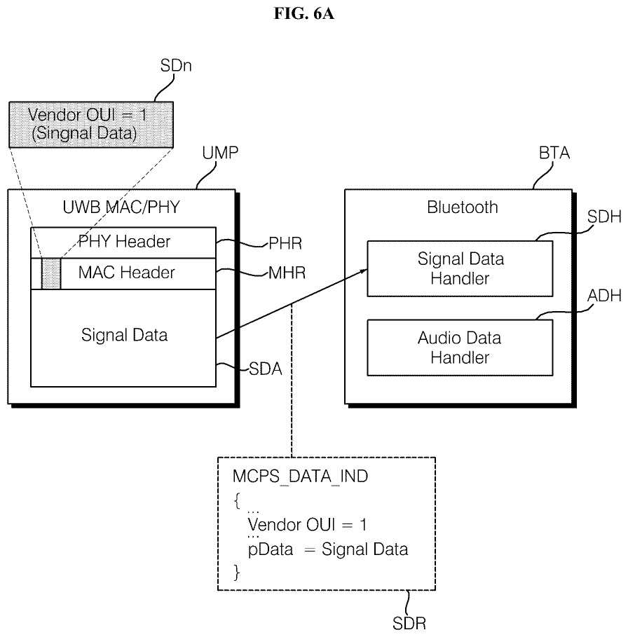

FIGS. 5A and 5B are diagrams for explaining an operation of a wireless audio transmitting device.

Referring to the drawing, the signal data handler SDH in the Bluetooth audio BTA of the wireless audio transmitting device 50 may define an identifier for distinguishing between signal data and audio data by using the Vendor OUI Field of the UWB MAC Header.

FIG. 5A illustrates signal data SDT when the Vendor OUI is ‘l’, and FIG. 5B illustrates audio data ADT when the Vendor OUI is ‘2’.

In particular, the Bluetooth audio BTA of the wireless audio transmitting device 50 may transmit signal data SDT for codec and QoS configuration used in the UWB audio service.

Meanwhile, when the wireless audio transmitting device 50 transmits the signal data SDT to the Media access control or physical layer (MAC/PHY) (UMP) of UWB, Vendor OUI, which is UWB MAC Header, may be set to ‘l’ and transmitted.

Meanwhile, in the wireless audio receiving device 100, when codec and QoS configuration are completed, audio data may be transmitted from the audio codec to Bluetooth audio BTA, and Bluetooth Audio BTA may be transmitted to the Media access control or physical layer (MAC/PHY) (UMP) of UWB by setting the Vendor OUI, which is UWB MAC Header, to ‘2’.

In addition, the wireless audio transmitting device 50 may transmit audio data to the wireless audio receiving device 100 with respect to Media access control or physical layer (MAC/PHY) (UMP) of UWB. Accordingly, even when the wireless environment is complicated, it is possible to stably receive audio wirelessly and output sound.

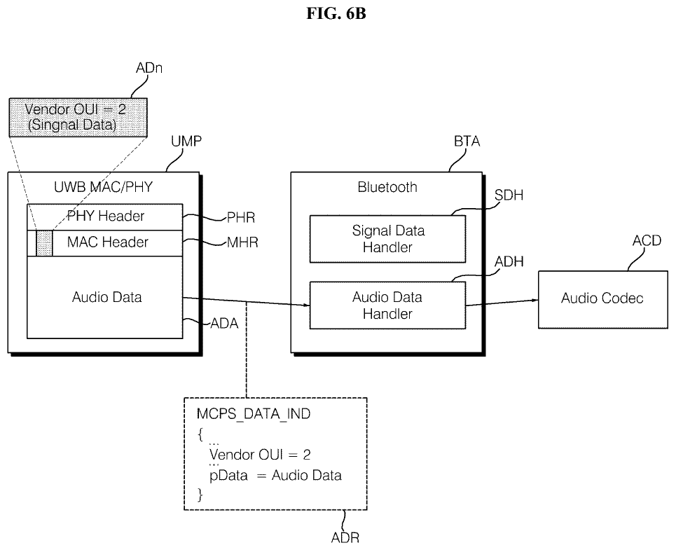

FIGS. 6A and 6B are diagrams for explaining an operation of a wireless audio receiving device.

Referring to the drawing, an identifier for distinguishing between signal data and audio data of Bluetooth audio (BTA) may be defined through the MCPS interface of the wireless audio receiving device 100.

FIG. 6A illustrates signal data SDR when the Vendor OUI is ‘l’, and FIG. 6B illustrates audio data ADR when the Vendor OUI is ‘2’.

When the Media access control or physical layer (MAC/PHY) (UMP) of UWB of the wireless audio receiving device 100 receives data having Vendor OUI, which is the UWB MAC Header, that is set to ‘l’, Bluetooth audio BTA may move to the signal data handler SDH.

In particular, the Bluetooth audio BTA of the wireless audio receiving device 100 may receive codec and QoS information used in the UWB audio service through a signal data handler SDH, and set information necessary for audio data reception.

Meanwhile, when the codec and QoS configuration for UWB audio service are completed, data whose Vendor OUI, which is the UWB MAC Header, is ‘2’ is received, and Bluetooth audio BTA may move to the audio data handler ADH.

The Bluetooth audio BTA sets a reproducing time for audio data received through an audio data handler (ADH), and the audio data having set reproducing time is transmitted to an audio codec. Accordingly, even when the wireless environment is complicated, it is possible to stably receive audio wirelessly and output sound.

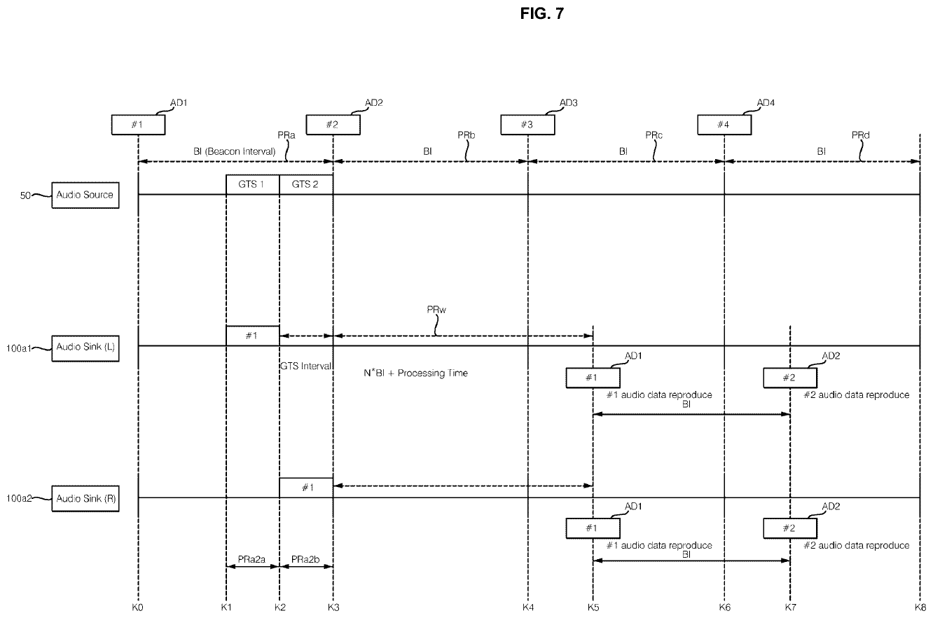

FIG. 7 is a diagram for explaining an UWB audio reproducing time synchronization.

Referring to FIG. 7, the wireless audio transmitting device 50 may sequentially transmit first to fourth audio data AD1 to AD4 to a plurality of wireless audio receiving devices 100al and 100a2 respectively.

In particular, the wireless audio transmitting device 50 may sequentially transmit the first to fourth audio data AD1 to AD4 for each channel in a beacon interval.

FIG. 7 illustrates that a first audio data AD1 is generated at time K0, transmitted to a first wireless audio receiving device 100al in an interval PRa2a between time K1 and time K2, and transmitted to a second wireless audio receiving device 100a2 in an interval PRa2b between time K2 and time K3.

Meanwhile, the interval PRa2a and the interval PRa2b may be set respectively by a plurality of wireless audio receiving devices 100al and 100a2 that receive audio data.

Similarly, at time K3, a second audio data AD2 is generated, and transmitted to the first wireless audio receiving device 100al and the second wireless audio receiving device 100a2, within a second beacon interval PRb.

Similarly, at time K4, a third audio data AD3 is generated, and transmitted to the first wireless audio receiving device 100al and the second wireless audio receiving device 100a2, within a third beacon interval PRc.

Similarly, at time K6, a fourth audio data AD4 is generated, and transmitted to the first wireless audio receiving device 100al and the second wireless audio receiving device 100a2, within a fourth beacon interval PRd.

Meanwhile, in order to synchronize and reproduce the first audio data AD1 received in a first beacon interval PRa in the plurality of wireless audio receiving devices 100al and 100a2, it is preferable that it is not reproduced in a second beacon interval PRb, but reproduced at the time K5 in the third beacon interval PRc.

That is, after audio data is reproduced, it is preferable that it is reproduced not in the next beacon interval but in the beacon interval after next.

Meanwhile, it is preferable that the interval PRw from the audio data reception completion time K3 to the reproducing start point K5 is greater than the length of the beacon interval. Accordingly, it is possible to stably synchronize and reproduce audio data.

Meanwhile, after the first audio data AD1 is reproduced at the time K5, it is preferable that the second audio data AD2 is spaced apart by the beacon interval and reproduced at the time K7. Accordingly, it is possible to stably synchronize and reproduce audio data.

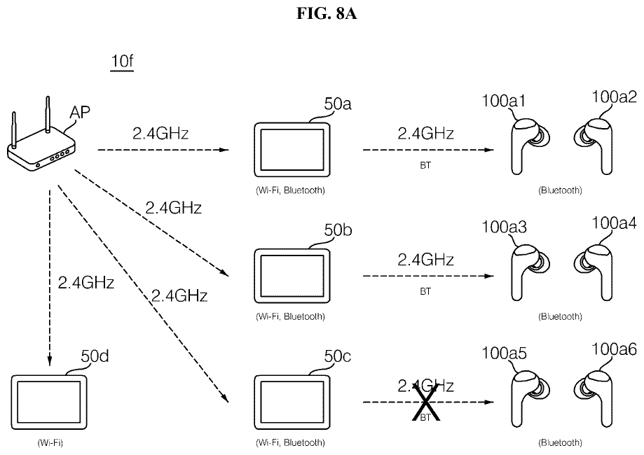

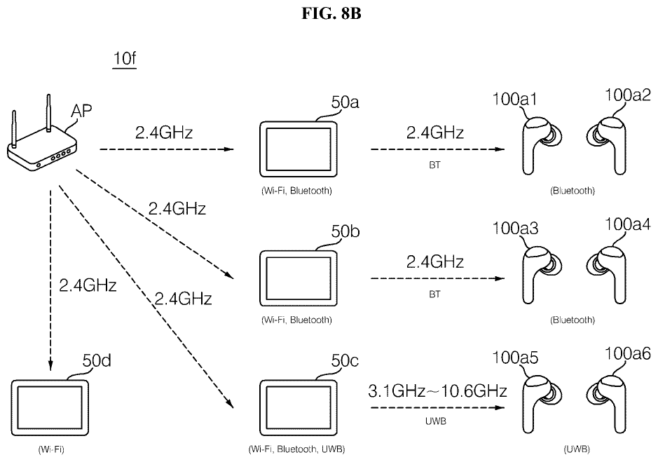

FIGS. 8A and 8B illustrate a wireless audio system 10f including an AP device (AP), a plurality of wireless audio transmitting devices 50a to 50d, and a plurality of wireless audio receiving devices 100al to 100a6.

As shown in FIG. 8A, in a complicated wireless environment, between the plurality of wireless audio transmitting devices 50a to 50d and the plurality of wireless audio receiving devices 100al to 100a6, when audio is transmitted wirelessly by using Bluetooth communication which is the same first communication standard, audio data transmission becomes impossible due to frequency interference.

FIG. 8A illustrates that audio data transmission is impossible due to frequency interference, between a third wireless audio transmitting device 50c and the plurality of wireless audio receiving devices 100a5 to 100a6.

In order to solve this problem, an embodiment of the present disclosure utilizes a second communication standard having a larger frequency band and a larger bandwidth than the first communication standard. The second communication standard may be UWB.

As shown in FIG. 8B, in a complicated wireless environment, it is preferable that among a plurality of wireless audio transmitting devices 50a to 50d and a plurality of wireless audio receiving devices 100al to 100a6, devices excluding the third wireless audio transmitting device 50c and the plurality of wireless audio receiving devices 100a5 to 100a6 use Bluetooth communication which is the first communication standard, and the third wireless audio transmitting device 50c and the plurality of wireless audio receiving devices 100a5 to 100a6 use UWB communication. Accordingly, it is possible to stably transmit and receive wireless audio data even in a complicated wireless environment.

Meanwhile, since ultra-wideband UWB communication has characteristics of low frequency congestion and resistance to interference, it may be suitable in a complicated wireless environment.

Accordingly, UWB communication is used to detect indoor positioning, but in the present disclosure, it is assumed to be used for audio service.

Meanwhile, UWB communication may be provided in standard specifications such as IEEE 802.15.4.

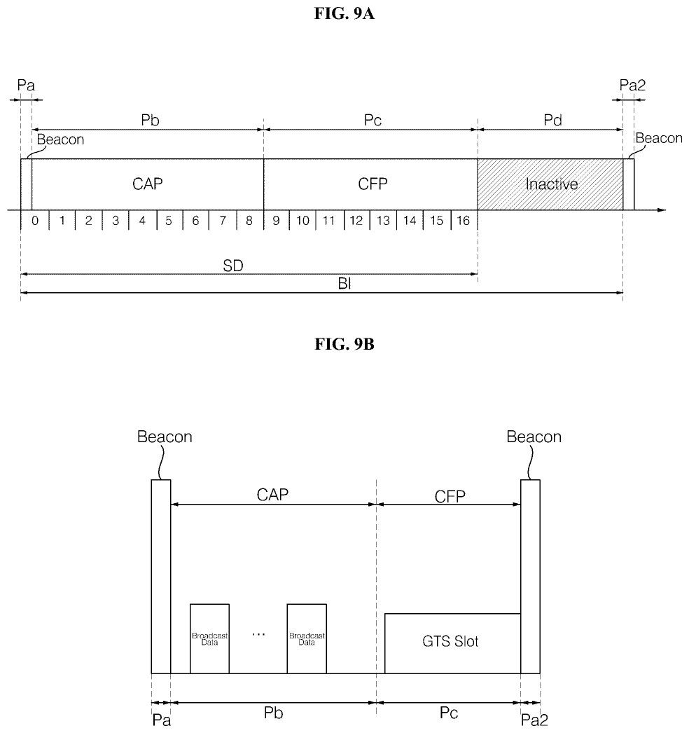

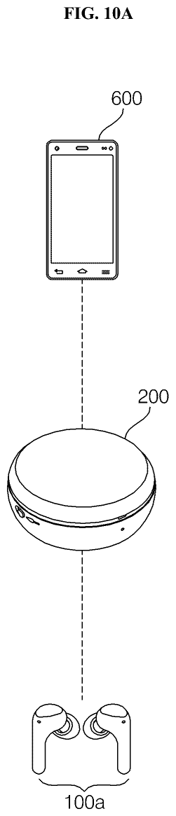

FIG. 9A is a diagram illustrating a beacon interval in ultra-wideband communication.

As shown in FIG. 9A, according to the IEEE 802.15.4 standard for ultra-wideband (UWB) communication, the beacon interval BI includes a first period Pa configured to transmit a beacon signal (Beacon), a second period Pb corresponding to a contention access period CAP, a third period Pc corresponding to a contention free period CFP, and an inactive period Pd.

Meanwhile, an active period includes a first period Pa, a second period Pb, and a third period Pc, and the active period may be referred to as a superframe duration SD.

Meanwhile, after the end of the beacon interval BI, the first period Pa2 configured to transmit the beacon signal (Beacon) is disposed again in an additional beacon interval BI.

The wireless audio transmitting device 50 may transmit audio data to the wireless audio receiving device 100, by using the beacon interval BI of FIG. 9A through ultra-wideband communication.

Meanwhile, the wireless audio receiving device 100 may receive audio data from the wireless audio receiving device 100, by using the beacon interval BI of FIG. 9A through ultra-wideband communication.

Meanwhile, in the inactive period rather than the active period, the wireless audio transmitting device 50 and the wireless audio receiving device 100 operate with a low power.

FIG. 9B is a diagram for explaining FIG. 9A.

Referring to the drawing, FIG. 9B is similar to FIG. 9A, but shows only an active period in the beacon interval BI.

The beacon interval BI includes a first period Pa configured to transmit a beacon signal (Beacon), a second period Pb corresponding to a contention access period CAP, and a third period Pc corresponding to a contention free period CFP.

Meanwhile, the second period Pb corresponds to a period configured to transmit broadcast data.

Meanwhile, the third period Pc is a period for unicast data transmission, and includes a guaranteed time slot.

According to communication standards, in order for the wireless audio transmitting device 50 to transmit unicast audio data in a unicast method, the wireless audio receiving device 100 must be connected to the wireless audio transmitting device 50.

Meanwhile, in order for the wireless audio transmitting device 50 to transmit unicast audio data in a unicast method, a PAN coordinator PNb in the transceiver 135b inside the wireless audio transmitting device 50 assigns a guaranteed time slot GTS, and transmits information related to the assigned guaranteed time slot GTS to the wireless audio receiving device 100.

In response to this, the wireless audio receiving device 100 receives unicast audio data through the guaranteed time slot GTS in the third period Pc, based on the information related to the assigned guaranteed time slot GTS.

Meanwhile, according to communication standards, in order for the wireless audio transmitting device 50 to transmit broadcast audio data, a plurality of wireless audio receiving devices 100 must be connected to the wireless audio transmitting device 50.

Meanwhile, in order to transmit broadcast audio data to a plurality of wireless audio receiving devices, the PAN coordinator PNb in the transceiver 135b inside the wireless audio transmitting device 50 checks an empty period during a contention access period in the second period Pb, and assigns and transmits broadcast audio data in the empty period.

According to this method, transmission time of broadcast audio data cannot be guaranteed due to interference of neighboring signals.

In addition, since the wireless audio receiving device 100 does not know when the broadcast audio data will be received, it needs to monitor all contention access periods within the second period Pb. Accordingly, there is a disadvantage in that power consumption is significant.

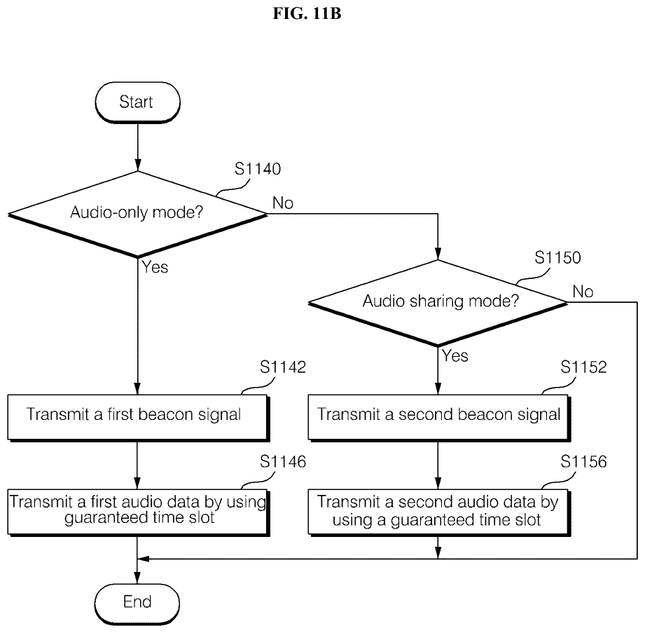

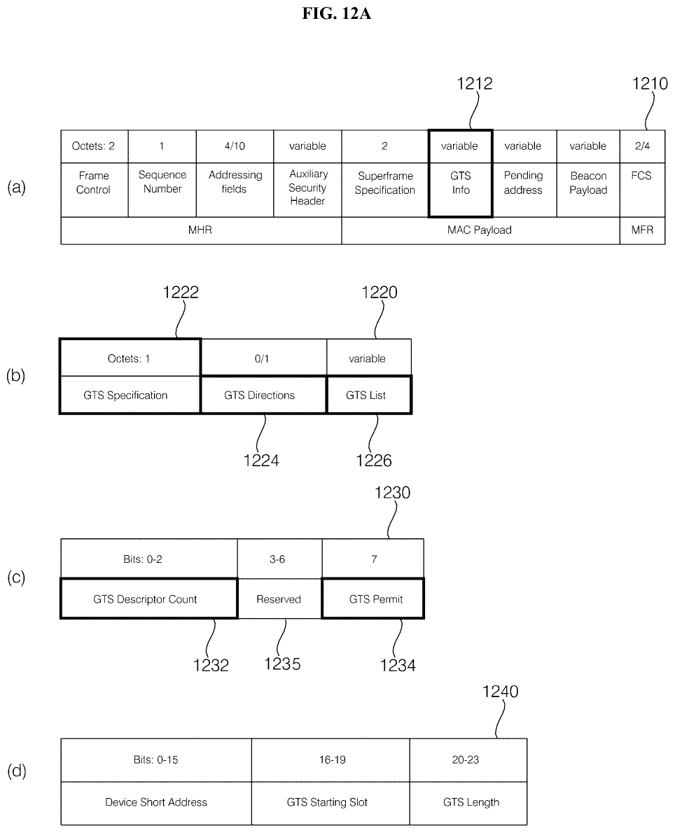

Accordingly, in the present disclosure, a method for sharing audio data in ultra-wideband communication with broadcast audio data in a simple and rapid manner is proposed. This will be described with reference to FIG. 11A and below.

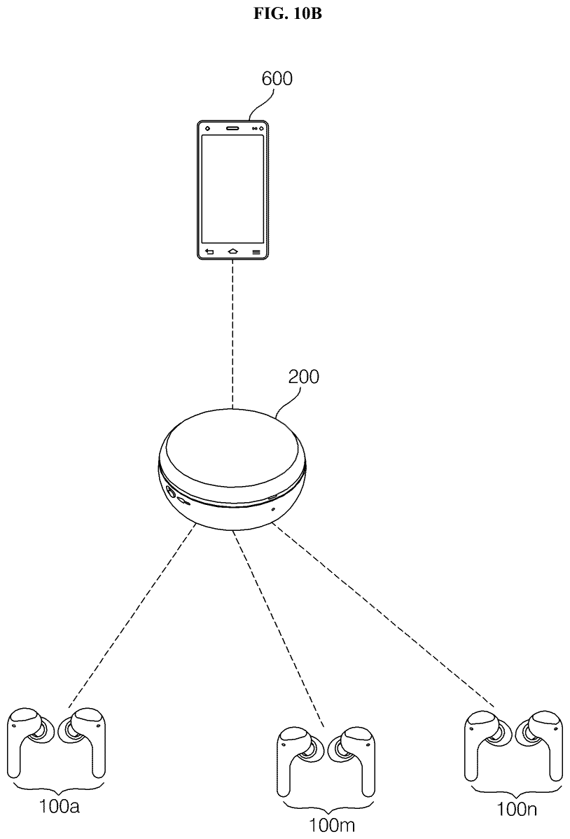

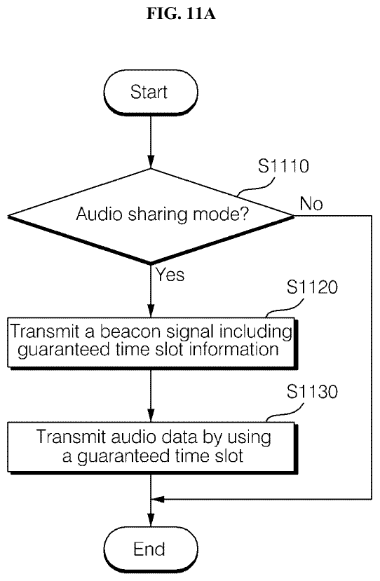

FIG. 10A is a diagram illustrating an example of an audio exclusive transmission mode in ultra-wideband communication.

Referring to FIG. 10A, in an audio exclusive transmission mode in ultra-wideband communication, a mobile terminal 600 may transmit unicast audio data to the wireless audio receiving device 100a.

At this time, the mobile terminal 600 may transmit the unicast audio data to a cradle device 200 that can charge the wireless audio receiving device 100a by placing it therein, and the cradle device 200 may transmit the unicast audio data to the wireless audio receiving device 100a.

At this time, ultra-wideband communication may be performed between the cradle device 200 and the wireless audio receiving device 100a.

Meanwhile, the mobile terminal 600 and the cradle device 200 may exchange audio data through ultra-wideband communication or other communication method.

FIG. 10B is a diagram illustrating an example of an audio sharing mode in ultra-wideband communication.

Referring to FIG. 10B, in an audio sharing mode in ultra-wideband communication, the mobile terminal 600 may transmit broadcast audio data to a plurality of wireless audio receiving devices 100a, 100m, and 100n.

At this time, the mobile terminal 600 may transmit audio data to a cradle device 200 that can charge the first wireless audio receiving device 100a, among the plurality of wireless audio receiving devices 100a, 100m, and 100n, by placing it therein, and the cradle device 200 may transmit the broadcast audio data to the plurality of wireless audio receiving devices 100a, 100m, and 100n.

At this time, ultra-wideband communication may be performed between the cradle device 200 and the plurality of wireless audio receiving devices 100a, 100m, and 100n.

Meanwhile, the mobile terminal 600 and the cradle device 200 may exchange audio data through ultra-wideband communication or other communication method.

At this time, the audio data transmitted between the mobile terminal 600 and the cradle device 200 may be unicast audio data or broadcast audio data.

For example, when the audio data transmitted between the mobile terminal 600 and the cradle device 200 is unicast audio data, the audio sharing mode may be executed by the cradle device 200, not the mobile terminal 600.

As another example, when the audio data transmitted between the mobile terminal 600 and the cradle device 200 is broadcast audio data, the audio sharing mode may be executed by the cradle device 200 as well as the mobile terminal 600.

FIG. 11A is a flowchart illustrating an operating method of a wireless audio transmitting device according to an embodiment of the present disclosure.

Referring to FIG. 11A, the transceiver 135b in the wireless audio transmitting device 50 determines whether it is an ultra-wideband communication-based audio sharing mode (S1110), and if applicable, transmits a beacon signal (Beacon) including broadcast information of guaranteed time slot (S1120).

Next, after transmitting the beacon signal (Beacon), the transceiver 135b inside the wireless audio transmitting device 50 transmits broadcast audio data to at least one non-connected wireless audio receiving device 100, by using a guaranteed time slot within a contention free period. (S1130).

That is, the wireless audio transmitting device 50 according to an embodiment of the present disclosure includes a transceiver 135b configured to transmit an audio signal to the wireless audio receiving device 100 through ultra-wideband communication, and the transceiver 135b transmits broadcast audio data to at least one wireless audio receiving device 100 that is not connected, by using a guaranteed time slot within the contention free period, in the beacon interval BI including the contention free period, in a first mode for audio sharing.

As described above, since the contention free period is used instead of the contention access period of FIG. 9a or FIG. 9b for transmission of broadcast audio data, wireless audio data can be easily and quickly shared through ultra-wideband communication. Furthermore, wireless audio data can be stably shared.

Meanwhile, the transceiver 135b inside the wireless audio transmitting device 50 may transmit a beacon signal (Beacon) including broadcast information of guaranteed time slot before transmission of broadcast audio data, in the first mode. Accordingly, it is possible to conveniently and quickly share wireless audio data through ultra-wideband communication.

In particular, in the case of including broadcast information of guaranteed time slot in the received beacon signal (Beacon) in a state of not being connected to the wireless audio transmitting device 50, the transceiver 135 inside at least one wireless audio receiving device 100 that is not connected receives broadcast audio data based on a guaranteed time slot after the beacon signal (Beacon), and the sound output device 160 outputs sound corresponding to the broadcast audio data.

Accordingly, it is possible to conveniently and quickly share wireless audio data through ultra-wideband communication.

In particular, since broadcast audio data is received through a specific guaranteed time slot in the contention free period rather than a contention access period, there is no need to monitor the contention access period in the second period Pb, thereby enabling efficient power management.

Meanwhile, the beacon signal (Beacon) for the first mode may further include information on the number of guaranteed time slot, start information of guaranteed time slot, and length information of guaranteed time slot for transmission of broadcast audio data.

Meanwhile, the beacon signal (Beacon) for the first mode may further include transmission or reception direction information of guaranteed time slot and availability information of guaranteed time slot.

Meanwhile, the transceiver 135b inside the wireless audio transmitting device 50 may transmit a beacon signal (Beacon) including broadcast information of guaranteed time slot in the first period Pa, and transmit broadcast audio data by using guaranteed time slot in the third period Pc, in the beacon interval BI including the first period Pa configured to transmit a beacon signal (Beacon), the second period Pb corresponding to contention access period, and the third period Pc corresponding to contention free period, in the first mode. Accordingly, it is possible to conveniently and quickly share wireless audio data through ultra-wideband communication.

FIG. 11B is a flowchart illustrating an operating method of a wireless audio transmitting device according to another embodiment of the present disclosure.

Referring to FIG. 11B, the transceiver 135b inside the wireless audio transmitting device 50 determines whether it is an ultra-wideband communication-based audio exclusive transmission mode (S1140), and if applicable, may transmit a beacon signal including unicast information of guaranteed time slot (S1142).

Next, after transmitting a beacon signal (Beacon), the transceiver 135b inside the wireless audio transmitting device 50 transmits unicast audio data to the connected wireless audio receiving device 100a, as shown in FIG. 10A, by using guaranteed time slot in the contention free period (S1146).

In response to this, the transceiver 135b inside the wireless audio receiving device 100a receives unicast audio data based on guaranteed time slot after a beacon signal, in the case of including unicast information of guaranteed time slot in the received beacon signal in a state of being connected to the wireless audio transmitting device 50.

In addition, the sound output device 160 in the wireless audio receiving device 100a may output sound corresponding to the unicast audio data.

As described above, since the contention free period is used instead of the contention access period of FIG. 9a or FIG. 9b for transmission of unicast audio data, wireless audio data can be easily and quickly transmitted through ultra-wideband communication.

Meanwhile, the beacon signal (Beacon) for the audio-only mode may further include, for transmission of unicast audio data, information on the number of guaranteed time slot, start information of guaranteed time slot, length information on guaranteed time slot, and information on the connected wireless audio receiving device 100.

In particular, compared to the beacon signal for the audio sharing mode, the beacon signal (Beacon) for the audio-only mode has a difference in that it further includes information on the connected wireless audio receiving device 100.

Meanwhile, the beacon signal (Beacon) for the audio-only mode may further include transmission or reception direction information of the guaranteed time slot and availability information of guaranteed time slot.

Meanwhile, not in the audio-only mode at step 1140 (S1140), or after transmission of unicast audio data at step 1146 (S1146), step 1150 (S1150) may be performed.

At step 1150 (S1150), the transceiver 135b inside the wireless audio transmitting device 50 determines whether it is in an ultra-wideband communication-based audio sharing mode (S1150), and if applicable, transmits a second beacon signal (Beacon) including broadcast information of guaranteed time slot (S1152).

Next, after transmitting the second beacon signal (Beacon), the transceiver 135b inside the wireless audio transmitting device 50 transmits broadcast audio data to at least one of the plurality of wireless audio receiving devices 100m and 100n that are not connected, by using a guaranteed time slot within the contention free period, as shown in FIG. 10B (S1156).

At this time, the transceiver 135b in the wireless audio transmitting device 50 may also transmit the broadcast audio data to the connected wireless audio receiving device 100a, by using a guaranteed time slot in the contention free period.

As described above, since the contention free period is used instead of the contention access period of FIG. 9a or FIG. 9b for transmission of broadcast audio data, wireless audio data can be easily and quickly shared through ultra-wideband communication. Furthermore, wireless audio data can be stably shared.

In particular, the transceiver 135 in at least one of the plurality of wireless audio receiving devices 100m and 100n that are not connected receives broadcast audio data based on guaranteed time slot after the second beacon signal (Beacon), in a state of not being connected to the wireless audio transmitting device 50, when broadcast information of guaranteed time slot is contained in the received second beacon signal (Beacon), and the sound output device 160 outputs sound corresponding to the broadcast audio data.

Accordingly, it is possible to conveniently and quickly share wireless audio data through ultra-wideband communication.

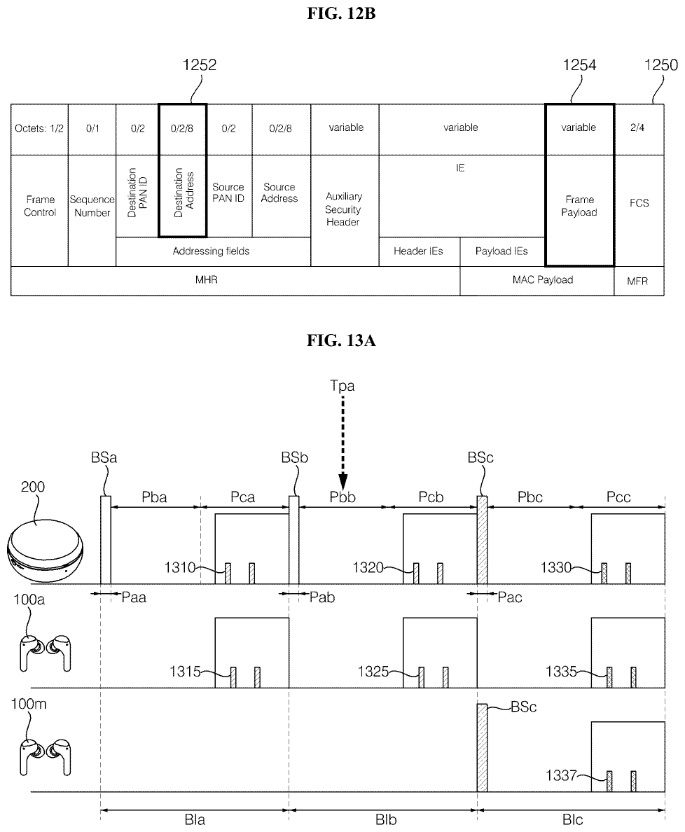

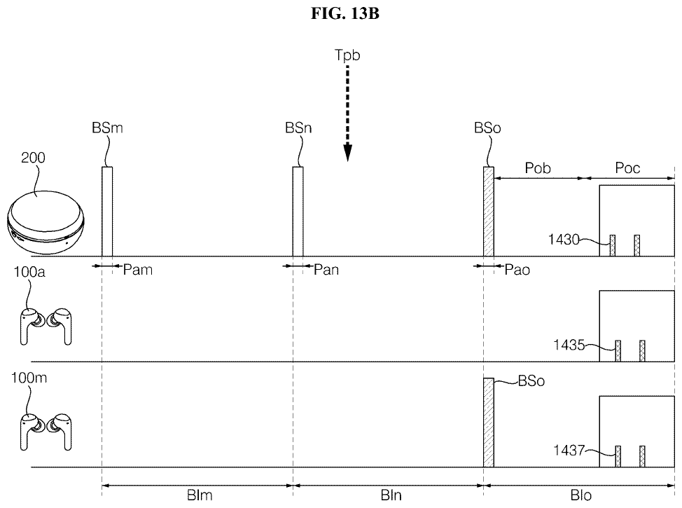

FIGS. 12A to 13B are diagrams for explaining FIG. 11A or 11B.

FIG. 12A illustrates a beacon frame 1210 inside a beacon signal of an ultra-wideband communication.

Referring to the drawing, the beacon frame 1210 of FIG. 12A (a) includes frame control, sequence number, addressing field, auxiliary security header, superframe specification, GTS information 1212, pending address, beacon payload, and the like.

FIG. 12A (b) illustrates the GTS information 1212 of FIG. 12A (a).

Referring to FIG. 12A (b), the GTS information 1212 includes a GTS specification 1222, GTS directions 1224, a GTS list 1226.

The GTS directions 1224 may include transmission or reception direction information of the guaranteed time slot.

In particular, the GTS directions 1224 may include information indicating whether the purpose of the guaranteed time slot is for transmission or reception.

FIG. 12A (c) illustrates the GTS specification 1222 of FIG. 12A (b).

Referring to FIG. 12A (c), the GTS specification 1222 includes a GTS descriptor count 1232, a reserved 1235, a GTS permit 1234.

The GTS descriptor count 1232 may include information on the number of guaranteed time slots.

The GTS permit 1234 may include availability information of the guaranteed time slot.

Meanwhile, the reserved 1235 in the GTS specification 1222 in the GTS information 1212 may include broadcast information of guaranteed time slot or unicast information of guaranteed time slot.

For example, when the reserved 1235 is ‘O’ bit, it may indicate unicast information of guaranteed time slot.

As another example, when the reserved 1235 is ‘l’ bit, it may indicate broadcast information of guaranteed time slot.

FIG. 12A (d) illustrates the GTS list 1226 of FIG. 12A (b).

Referring to FIG. 12A (d), the GTS list 1226 includes a device short address, a GTS starting slot, and a GTS length.

The GTS starting slot may include start information of the guaranteed time slot.

The GTS length may include length information of guaranteed time slot.

FIG. 12B illustrates a MAC frame 1250 of ultra-wideband communication.

Referring to FIG. 12B, a MAC frame 1250 includes a destination address 1252, a frame payload 1354, and the like.

The destination address 1252 may include address information of the connected wireless audio receiving device 100a, in the audio exclusive transmission mode.

For example, when the destination address 1252 is ‘0x1234’, it represents address information of the left wireless audio receiving device 100al of the wireless audio receiving device 100a, and when the destination address 1252 is ‘0x4567’, it represents address information of the right wireless audio receiving device 100a2 of the wireless audio receiving device 100a.

Meanwhile, the destination address 1252 may be changed to broadcast address information, when the audio only transmission mode is changed to the audio sharing mode.

For example, when switching to the audio sharing mode, the destination address 1252 may be changed from ‘0x1234’, ‘0x4567’ to ‘0xFFFF’.

In case of the audio exclusive transmission mode, the frame payload 1354 may include audio data of corresponding channel to the connected wireless audio receiving device 100a.

For example, in the case of the audio exclusive transmission mode, the frame payload 1354 may include audio data for a left channel.

As another example, in the case of the audio exclusive transmission mode, the frame payload 1354 may include audio data for a right channel.

Meanwhile, in the case of the audio sharing mode, since broadcast audio data must be transmitted to a wireless audio receiving device not connected to the wireless audio transmitting device, the frame payload 1354 must include all audio data for each channel to 100a.

In this case, in order to separate audio data for each channel, the frame payload 1354 may include delimiter information to separate the channels.

For example, in the case of the audio sharing mode, the frame payload 1354 may include left channel audio data, delimiter information, and right channel audio data together.

FIG. 13A is a diagram illustrating that an audio sharing mode is performed after an audio exclusive transmission mode is performed. FIG. 13A illustrates the cradle device 200 as an example of the wireless audio transmitting device 50.

Referring to FIG. 13A, the transceiver 135b of the wireless audio transmitting device 50 transmits a beacon signal BSa in a first period Paa during a first beacon interval BIa according to an audio exclusive transmission mode.

The beacon signal BSa at this time may include unicast information of guaranteed time slot.

In particular, in the beacon signal BSa, the reserved 1235 in the GTS specification 1222 in the GTS information 1212 of FIG. 12A may be ‘0’ bit.

Meanwhile, the beacon signal (BSa) may further contain information on the number of guaranteed time slots, start information of guaranteed time slot, length information of guaranteed time slot, and information on the connected wireless audio receiving device 100, for transmission of unicast audio data.

Meanwhile, the beacon signal BSa may further contain transmission or reception direction information of guaranteed time slot and availability information of guaranteed time slot.

Meanwhile, the transceiver 135b of the wireless audio transmitting device 50 does not transmit data in a second period Pba corresponding to the contention access period during the first beacon interval BIa.

Meanwhile, the transceiver 135b of the wireless audio transmitting device 50 transmits unicast audio data 1310 by using the guaranteed time slot, in a third period Pca corresponding to the contention free period during the first beacon interval BIa.

In response to this, the transceiver 135 of the first wireless audio receiving device 100a connected to the wireless audio transmitting device 50 may receive the beacon signal BSa, and may receive unicast audio data 1315 by using the guaranteed time slot, in the third interval Pca, based on the unicast information of guaranteed time slot, in the beacon signal (BSa).

In addition, the sound output device 160 of the first wireless audio receiving device 100a may output a sound corresponding to the unicast audio data 1315.

Accordingly, wireless audio data can be stably transmitted through ultra-wideband communication, at between the wirelessly connected wireless audio transmitting device 50 and the first wireless audio receiving device 100a.

Meanwhile, the transceiver 135 of the second wireless audio receiving device 100m not connected to the wireless audio transmitting device 50 receives the beacon signal BSa, but does not receive the unicast audio data 1315 by using the guaranteed time slot, in the third period Pca, based on the unicast information of the guaranteed time slot in the beacon signal (Beacon).

Next, the transceiver 135b of the wireless audio transmitting device 50 transmits the beacon signal BSb, in the first period Pab during the second beacon interval Bib, according to the audio exclusive transmission mode.

The beacon signal BSb at this time may include unicast information of the guaranteed time slot.

Meanwhile, the transceiver 135b of the wireless audio transmitting device 50 does not transmit data, in the second period Pbb corresponding to the contention access period during the second beacon interval BIb.

Meanwhile, the transceiver 135b of the wireless audio transmitting device 50 may transmit unicast audio data 1320 by using the guaranteed time slot, in the third period Pcb corresponding to the contention free period during the second beacon interval BIb.

In response to this, the transceiver 135 of the first wireless audio receiving device 100a connected to the wireless audio transmitting device 50 may receive the beacon signal BSb, and may receive unicast audio data 1325 by using the guaranteed time slot, in the third interval Pcb, based on the unicast information of guaranteed time slot in the beacon signal BSb.

In addition, the sound output device 160 of the first wireless audio receiving device 100a may output a sound corresponding to the unicast audio data 1325.

Meanwhile, the transceiver 135 of the second wireless audio receiving device 100m not connected to the wireless audio transmitting device 50 receives the beacon signal BSb, but does not receive unicast audio data 1325 by using the guaranteed time slot, in the third period Pcb, based on the unicast information of guaranteed time slot in the beacon signal BSb,

Meanwhile, the transceiver 135b of the wireless audio transmitting device 50 may receive broadcast switching information, at a first time point TPa during the second beacon interval BIb.

For example, the transceiver 135b of the wireless audio transmitting device 50 may receive broadcast switching information for music sharing, at a first time point TPa during the second beacon interval BIb.

Accordingly, the transceiver 135b of the wireless audio transmitting device 50 switches from the audio exclusive transmission mode to the audio sharing mode, in the third beacon interval BIc after the second beacon interval BIb.

Next, the transceiver 135b of the wireless audio transmitting device 50 transmits the beacon signal BSc, in the first period Pac during the third beacon interval BIc, according to the audio sharing mode.

The beacon signal BSc at this time may include broadcast information of guaranteed time slot.

In particular, in the beacon signal BSc, the reserved 1235 in the GTS specification 1222 in the GTS information 1212 of FIG. 12A is ‘l’ bit.

Meanwhile, the beacon signal BSc may further include information on the number of guaranteed time slot, start information of guaranteed time slot, and length information of guaranteed time slot for transmission of broadcast audio data.

Unlike the other beacon signal BSa, BSa, the beacon signal BSc at this time does not include information related to the connected wireless audio receiving device 100.

Meanwhile, the beacon signal BSc may further include transmission or reception direction information of guaranteed time slot and availability information of guaranteed time slot.

Meanwhile, the transceiver 135b of the wireless audio transmitting device 50 does not transmit data, in the second period Pbc corresponding to the contention access period during the third beacon interval BIc.

Meanwhile, the transceiver 135b of the wireless audio transmitting device 50 may transmit broadcast audio data 1330 by using a guaranteed time slot in the third period Pcc corresponding to the non-contention period in the third beacon interval BIc.

In response to this, the transceiver 135 of the first wireless audio receiving device 100a connected to the wireless audio transmitting device 50 may receive the beacon signal BSc, and may receive broadcast audio data 1335 by using a guaranteed time slot in the third period Pcc, based on the broadcast information of guaranteed time slot in the beacon signal BSc.

In addition, the sound output device 160 of the first wireless audio receiving device 100a may output a sound corresponding to the broadcast audio data 1335.

Accordingly, even if the audio exclusive transmission mode is switched to the audio sharing mode, the first wireless audio receiving device 100a connected to the wireless audio transmitting device 50 can seamlessly receive audio data.

Meanwhile, the transceiver 135 of the second wireless audio receiving device 100m not connected to the wireless audio transmitting device 50 may receive the beacon signal BSc, and receive broadcast audio data 1337 by using guaranteed time slot in the third period Pcc, based on the broadcast information of guaranteed time slot in the beacon signal BSc.

In addition, the sound output device 160 of the second wireless audio receiving device 100m may output a sound corresponding to the broadcast audio data 1337.

As described above, even when not connected to the wireless audio transmitting device 50, wireless audio data can be easily and quickly shared, based on the broadcast information of guaranteed time slot in the beacon signal BSc.

FIG. 13B illustrates that the audio sharing mode is performed directly without the audio exclusive transmission mode. In the drawing, the cradle device 200 is illustrated as an example of the wireless audio transmitting device 50.

Referring to FIG. 13B, the transceiver 135b of the wireless audio transmitting device 50 may transmit only beacon signals BSm and BSn, respectively, during a first beacon interval BIm and a second beacon interval BIn, according to a power saving mode.

The beacon signal BSm, BSn at this time may not include information related to guaranteed time slot.

Specifically, the beacon signal BSm, BSn may not include unicast information of guaranteed time slot or broadcast information of guaranteed time slot.

Meanwhile, the transceiver 135b of the wireless audio transmitting device 50 may receive broadcast switching information, at a second time point TPb during the second beacon interval BIn.

For example, the transceiver 135b of the wireless audio transmitting device 50 may receive broadcast switching information for music sharing, at a second time point TPb during the second beacon interval BIn.

Accordingly, the transceiver 135b of the wireless audio transmitting device 50 enters the audio sharing mode, in the third beacon interval BIO after the second beacon interval BIn.

Next, the transceiver 135b of the wireless audio transmitting device 50 transmits the beacon signal BSo, in a first period Pao during the third beacon interval Bio, according to the audio sharing mode.

The beacon signal BSo at this time may include broadcast information of guaranteed time slot.

In particular, in the beacon signal BSo, the reserved 1235 in the GTS specification 1222 in the GTS information 1212 of FIG. 12A may be ‘l’ bit.

Meanwhile, the beacon signal BSo may further include information on the number of guaranteed time slot, start information of guaranteed time slot, and length information of guaranteed time slot for transmission of broadcast audio data.

Meanwhile, the beacon signal BSo may further include transmission or reception direction information of guaranteed time slot and availability information of guaranteed time slot.

Meanwhile, the transceiver 135b of the wireless audio transmitting device 50 does not transmit data, in a second period Pbo corresponding to the contention access period during the third beacon interval BIO.

Meanwhile, the transceiver 135b of the wireless audio transmitting device 50 may transmit broadcast audio data 1430 by using the guaranteed time slot, in a third period Pco corresponding to the contention free period during the third beacon interval BIo.

In response to this, the transceiver 135 of the first wireless audio receiving device 100a not connected to the wireless audio transmitting device 50 may receive the beacon signal BSo, and may receive broadcast audio data 1435 by using the guaranteed time slot, in the third period Pco, based on the broadcast information of guaranteed time slot, in the beacon signal BSo.

In addition, the sound output device 160 of the first wireless audio receiving device 100a may output a sound corresponding to the broadcast audio data 1435.

Meanwhile, the transceiver 135 of the second wireless audio receiving device 100m not connected to the wireless audio transmitting device 50 may receive the beacon signal BSo, and receive broadcast audio data 1437 by using the guaranteed time slot, in the third period Pco, based on the broadcast information of guaranteed time slot in the beacon signal BSo.

In addition, the sound output device 160 of the second wireless audio receiving device 100m may output a sound corresponding to the broadcast audio data 1437.

As described above, even when not connected to the wireless audio transmitting device 50, wireless audio data can be easily and quickly shared, based on the broadcast information of guaranteed time slot in the beacon signal BSo.

Meanwhile, FIGS. 13A and 13B illustrate the cradle device 200 as an example of the wireless audio transmitting device 50, but it is not limited thereto, and the mobile terminal 600 is also possible.

A wireless audio transmitting device according to an embodiment of the present disclosure includes a transceiver configured to transmit an audio signal to a wireless audio receiving device through ultra-wideband communication, wherein the transceiver transmits broadcast audio data to at least one wireless audio receiving device not connected to the wireless audio transmitting device by using a guaranteed time slot within a contention free period among a beacon interval including the contention free period, in a first mode for audio sharing. Accordingly, it is possible to conveniently and quickly share wireless audio data through ultra-wideband communication. Furthermore, wireless audio data can be stably shared.

Meanwhile, the transceiver may transmit a beacon signal including broadcast information of the guaranteed time slot before transmission of the broadcast audio data, in the first mode. Accordingly, it is possible to conveniently and quickly share wireless audio data through ultra-wideband communication.

Meanwhile, the beacon signal may further include information on the number of the guaranteed time slot, start information of the guaranteed time slot, and length information of the guaranteed time slot for transmission of the broadcast audio data. Accordingly, it is possible to conveniently and quickly share wireless audio data through ultra-wideband communication.

Meanwhile, the beacon signal may further include transmission or reception direction information of the guaranteed time slot and availability information of the guaranteed time slot. Accordingly, it is possible to conveniently and quickly share wireless audio data through ultra-wideband communication.

Meanwhile, in the first mode, during a beacon interval including a first period for beacon signal transmission, a second period corresponding to a contention access period, and a third period corresponding to the contention free period, the transceiver may transmit a beacon signal including broadcast information of the guaranteed time slot in the first period, and transmit the broadcast audio data by using the guaranteed time slot in the third period. Accordingly, it is possible to conveniently and quickly share wireless audio data through ultra-wideband communication.

Meanwhile, the second period may correspond to a period for broadcast data transmission, and the third period may correspond to a period for unicast data transmission. Accordingly, it is possible to conveniently and quickly share wireless audio data through ultra-wideband communication.

Meanwhile, the transceiver may transmit the broadcast audio data to a previously connected wireless audio receiving device, and transmit the broadcast audio data to a wireless audio receiving device not connected to the wireless audio transmitting device. Accordingly, it is possible to conveniently and quickly share wireless audio data through ultra-wideband communication.

Meanwhile, the transceiver may transmit unicast audio data to a previously connected wireless audio receiving device by using the guaranteed time slot within the contention free period, in a second mode for audio exclusive transmission. Accordingly, it is possible to stably transmit wireless audio data through ultra-wideband communication.

Meanwhile, the transceiver may transmit a second beacon signal including unicast information of the guaranteed time slot before transmitting the unicast audio data, in the second mode. Accordingly, it is possible to stably transmit wireless audio data through ultra-wideband communication.

Meanwhile, the transceiver may transmit the unicast audio data in the second mode to a previously connected wireless audio receiving device, and in response to receiving broadcast switching information, transmit the beacon signal including the broadcast information of the guaranteed time slot in the first mode, and transmit the broadcast audio data to the at least one wireless audio receiving device by using a guaranteed time slot within the contention free period after transmitting the beacon signal. Accordingly, it is possible to conveniently and quickly share wireless audio data through ultra-wideband communication.

Meanwhile, the transceiver may transmit a second beacon signal including unicast information of the guaranteed time slot before transmitting the unicast audio data, in the second mode. Accordingly, it is possible to stably transmit wireless audio data through ultra-wideband communication.

Meanwhile, the second beacon signal may further include information on the number of guaranteed time slot, start information of the guaranteed time slot, length information of the guaranteed time slot, and information related to the wireless audio receiving device connected to the wireless audio transmitting device, for transmission of the unicast audio data. Accordingly, it is possible to stably transmit wireless audio data through ultra-wideband communication.

Meanwhile, the second beacon signal may further include transmission or reception direction information of the guaranteed time slot and availability information of the guaranteed time slot. Accordingly, it is possible to stably transmit wireless audio data through ultra-wideband communication.

Meanwhile, in the second mode, during a beacon interval including a first period configured to transmit a beacon signal, a second period corresponding to a contention access period, and a third period corresponding to the contention free period, the transceiver may transmit a second beacon signal including unicast information of the guaranteed time slot in the first period, and transmit the unicast audio data by using the guaranteed time slot in the third period. Accordingly, it is possible to stably transmit wireless audio data through ultra-wideband communication.

A wireless audio receiving device according to an embodiment of the present disclosure includes: a transceiver configured to receiver an audio signal from a wireless audio transmitting device through ultra-wideband communication; and a sound output device configured to output a sound corresponding to an audio signal from the transceiver, wherein in response to broadcast information of guaranteed time slot being included in a received beacon signal in a state of not being connected to the wireless audio transmitting device, the transceiver receives broadcast audio data based on guaranteed time slot after the beacon signal, and wherein the sound output device outputs a sound corresponding to the broadcast audio data. Accordingly, it is possible to conveniently and quickly share wireless audio data through ultra-wideband communication.

Meanwhile, in response to unicast information of guaranteed time slot being included in a received second beacon signal in a state of being connected to the wireless audio transmitting device, the transceiver may receive unicast audio data based on guaranteed time slot after the second beacon signal, and wherein the sound output device outputs a sound corresponding to the unicast audio data. Accordingly, it is possible to stably transmit wireless audio data through ultra-wideband communication.

A wireless audio output system according to an embodiment of the present disclosure includes a wireless audio transmitting device and a wireless audio receiving device, wherein the wireless audio transmitting device includes a transceiver that transmits an audio signal to the wireless audio receiving device through ultra-wideband communication, wherein the transceiver transmits broadcast audio data to at least one non-connected wireless audio receiving device by using a guaranteed time slot within a contention-free period, in a beacon period including the contention free period, in a first mode for audio sharing. Accordingly, it is possible to conveniently and quickly share wireless audio data through ultra-wideband communication.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

What is claimed is:

1. A wireless audio transmitting device comprising a transceiver configured to transmit an audio signal to a wireless audio receiving device through ultra-wideband communication,
wherein, in a first mode for audio sharing, the transceiver transmits broadcast audio data to at least one wireless audio receiving device not connected to the wireless audio transmitting device by using a guaranteed time slot within a contention free period among a beacon interval including the contention free period.

2. The wireless audio transmitting device of claim 1, wherein, in the first mode, the transceiver transmits a beacon signal including broadcast information of the guaranteed time slot before transmission of the broadcast audio data.

3. The wireless audio transmitting device of claim 2, wherein the beacon signal further comprises information on the number of the guaranteed time slot, start information of the guaranteed time slot, and length information of the guaranteed time slot for transmission of the broadcast audio data.

4. The wireless audio transmitting device of claim 3, wherein the beacon signal further comprises transmission or reception direction information of the guaranteed time slot and availability information of the guaranteed time slot.

5. The wireless audio transmitting device of claim 1, wherein, in the first mode, the transceiver transmits a beacon signal including broadcast information of the guaranteed time slot in a first period among during a beacon interval including the first period for beacon signal transmission, a second period corresponding to a contention access period, and a third period corresponding to the contention free period, and transmits the broadcast audio data by using the guaranteed time slot in the third period.

6. The wireless audio transmitting device of claim 5, wherein the second period corresponds to a period for broadcast data transmission, and
wherein the third period corresponds to a period for unicast data transmission.

7. The wireless audio transmitting device of claim 1, wherein the transceiver transmits the broadcast audio data to a previously connected wireless audio receiving device, and transmits the broadcast audio data to a wireless audio receiving device not connected to the wireless audio transmitting device.

8. The wireless audio transmitting device of claim 1, wherein the transceiver transmits unicast audio data to a previously connected wireless audio receiving device by using the guaranteed time slot within the contention free period, in a second mode for audio exclusive transmission.

9. The wireless audio transmitting device of claim 8, wherein, in the second mode, the transceiver transmits a second beacon signal including unicast information of the guaranteed time slot before transmitting the unicast audio data.

10. The wireless audio transmitting device of claim 8, wherein the transceiver transmits the unicast audio data to a previously connected wireless audio receiving device in the second mode, and in response to receiving broadcast switching information, transmits the beacon signal including the broadcast information of the guaranteed time slot in the first mode, and transmits the broadcast audio data to the at least one wireless audio receiving device by using a guaranteed time slot within the contention free period after transmitting the beacon signal.

11. The wireless audio transmitting device of claim 1, wherein the transceiver transmits a second beacon signal including unicast information of the guaranteed time slot before transmitting the unicast audio data, in the second mode.

12. The wireless audio transmitting device of claim 11, wherein the second beacon signal further comprises information on the number of guaranteed time slot, start information of the guaranteed time slot, length information of the guaranteed time slot, and information related to the wireless audio receiving device connected to the wireless audio transmitting device, for transmission of the unicast audio data.

13. The wireless audio transmitting device of claim 12, wherein the second beacon signal further comprises transmission or reception direction information of the guaranteed time slot and availability information of the guaranteed time slot.

14. The wireless audio transmitting device of claim 8, wherein, in the second mode, the transceiver transmits a second beacon signal including unicast information of the guaranteed time slot in a first period among a beacon interval including the first period configured to transmit a beacon signal, a second period corresponding to a contention access period, and a third period corresponding to the contention free period, and transmits the unicast audio data by using the guaranteed time slot in the third period.

15. A wireless audio receiving device comprising:
a transceiver configured to receiver an audio signal from a wireless audio transmitting device through ultra-wideband communication; and
a sound output device configured to output a sound corresponding to an audio signal from the transceiver,
wherein in response to broadcast information of guaranteed time slot being included in a received beacon signal in a state of not being connected to the wireless audio transmitting device, the transceiver receives broadcast audio data based on guaranteed time slot after the beacon signal, and
wherein the sound output device outputs a sound corresponding to the broadcast audio data.

16. The wireless audio receiving device of claim 15, wherein in response to unicast information of guaranteed time slot being included in a received second beacon signal in a state of being connected to the wireless audio transmitting device, the transceiver receives unicast audio data based on guaranteed time slot after the second beacon signal, and
wherein the sound output device outputs a sound corresponding to the unicast audio data.

17. A wireless audio output system comprising:
a wireless audio transmitting device; and
a wireless audio receiving device,
wherein the wireless audio transmitting device comprises a transceiver configured to transmit an audio signal to a wireless audio receiving device through ultra-wideband communication,
wherein, in a first mode for audio sharing, the transceiver transmits broadcast audio data to at least one wireless audio receiving device not connected to the wireless audio transmitting device by using a guaranteed time slot within a contention free period among a beacon interval including the contention free period.

18. The wireless audio output system of claim 17, wherein, in the first mode, the transceiver transmits a beacon signal including broadcast information of the guaranteed time slot before transmission of the broadcast audio data.

19. The wireless audio output system of claim 17, wherein the wireless audio receiving device comprises:
a second transceiver configured to receiver an audio signal from a wireless audio transmitting device through ultra-wideband communication; and
a sound output device configured to output a sound corresponding to an audio signal from the transceiver,
wherein in response to broadcast information of guaranteed time slot being included in a received beacon signal in a state of not being connected to the wireless audio transmitting device, the second transceiver receives broadcast audio data based on guaranteed time slot after the beacon signal, and
wherein the sound output device outputs a sound corresponding to the broadcast audio data.

20. The wireless audio output system of claim 19, wherein in response to unicast information of guaranteed time slot being included in a received second beacon signal in a state of being connected to the wireless audio transmitting device, the second transceiver receives unicast audio data based on guaranteed time slot after the second beacon signal, and
wherein the sound output device outputs a sound corresponding to the unicast audio data.
